(19) United States
(12) Patent Application Publication
(10) Pub. No.: US 2023/0271214 A1
(43) Pub. Date: Aug. 31, 2023

(54) PAINTING SYSTEM AND PAINTING METHOD

(71) Applicant: KABUSHIKI KAISHA YASKAWA DENKI, Fukuoka (JP)

(72) Inventors: Katsuhiko YOSHINO, Fukuoka (JP); Naoyuki OHTSUBO, Fukuoka (JP); Yasuhiro KATAOKA, Fukuoka (JP)

(21) Appl. No.: 18/112,791

(22) Filed: Feb. 22, 2023

(30) Foreign Application Priority Data
Feb. 28, 2022 (JP) 2022-030053

(51) Int. Cl. B05B 13/04; B25J 11/00

(52) U.S. Cl. CPC B05B 13/0452; B25J 11/0075; B05B 13/0431

(57) ABSTRACT

A painting system includes: a conveying apparatus that conveys a vehicle body having a door in a painting area; an operation robot that includes a base fixed in the painting area, a holding tool capable of holding the door, and a horizontal articulated arm that moves the holding tool, and opens the door of the vehicle body that is being conveyed by the conveying apparatus; and a painting robot that paints an inside of the vehicle body in a state where the door is opened by the operation robot. In the vertical direction, at least a portion of the horizontal articulated arm is disposed at a position lower than a height of a lower end of the door where the height of the lower end of the door is maintained by the conveying apparatus.

### CROSS-REFERENCE TO RELATED APPLICATIONS

This application is based on and claims priority from Japanese Patent Application No. 2022-030053, filed on Feb. 28, 2022, with the Japan Patent Office, the disclosure of which is incorporated herein in its entirety by reference.

### TECHNICAL FIELD

The present disclosure relates to a painting system and a painting method.

### BACKGROUND

Japanese Patent Laid-Open Publication No. 2018-126831 discloses a painting system including a plurality of painting robots painting vehicles being conveyed in a predetermined conveyance direction and an operation robot operating the opening/closing members of the vehicles, where the painting robots and the operation robot are fixed in a painting booth.

### SUMMARY

The present disclosure provides a painting system and a painting method, which are useful for a space saving.

According to an aspect of the present disclosure, a painting system includes: a conveying apparatus that conveys a vehicle body having a door in a painting area; an operation robot that includes a base fixed in the painting area, a holding tool capable of holding the door, and a horizontal articulated arm that moves the holding tool, and opens the door of the vehicle body that is being conveyed by the conveying apparatus; and a painting robot that paints an inside of the vehicle body in a state where the door is opened by the operation robot. In the vertical direction, at least a portion of the horizontal articulated arm is disposed at a position lower than a height of a lower end of the door where the height of the lower end of the door is maintained by the conveying apparatus.

According to an aspect of the present disclosure, a painting method includes: conveying a vehicle body having a door with a conveying apparatus in a painting area; opening the door of the vehicle body that is being conveyed by the conveying apparatus, with an operation robot including a base fixed in the painting area, a holding tool capable of holding the door, and a horizontal articulated arm that moves the holding tool; and painting an inside of the vehicle body with a painting robot in a state where the door is opened by the operation robot. During the opening of the door by the operation robot, in a vertical direction, at least a portion of the horizontal articulated arm operates at a position lower than a height of a lower end of the door where the height of the lower end of the door is maintained by the conveying apparatus.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a top view schematically illustrating an embodiment of a painting system.

FIG. 2 is a side view schematically illustrating an embodiment of an arrangement of robots in the painting system.

FIG. 3 is a side view illustrating an embodiment of an operation robot.

FIG. 4 is a top view illustrating the embodiment of the operation robot.

FIG. 5 is a side view schematically illustrating a height relationship between the operation robot and a door of a vehicle body.

FIG. 6 is a top view schematically illustrating an embodiment of an arrangement relationship between two operation robots.

FIG. 7 is a perspective view illustrating an embodiment of a painting robot.

FIG. 8 is a perspective view illustrating an embodiment of an opener robot.

FIG. 9 is a top view schematically illustrating an embodiment of an operation of the opener robot.

FIG. 10 is a top view schematically illustrating the embodiment of the operation of the opener robot.

FIG. 11 is a flowchart illustrating an embodiment of a series of processes performed by a control device.

FIGS. 12A and 12B are top views illustrating an embodiment of the operation of the operation robot.

FIGS. 13A and 13B are top views illustrating the embodiment of the operation of the operation robot.

FIG. 14 is a top view illustrating an embodiment of an operation of two operation robots.

FIG. 15 is a side view schematically illustrating an embodiment of the painting system.

FIG. 16 is a side view schematically illustrating an embodiment of the painting system.

FIG. 17 is a side view schematically illustrating an embodiment of the painting system.

### DETAILED DESCRIPTION

In the following detailed description, reference is made to the accompanying drawings which form a part hereof. The illustrative embodiments described in the detailed description, drawings, and claims are not meant to be limiting. Other embodiments may be utilized, and other changes may be made without departing from the spirit or scope of the subject matter presented herein.

Hereinafter, embodiments will be described with reference to the drawings. In the description, the same components or components having the same function will be denoted by the same reference numerals, and overlapping descriptions thereof will be omitted. In some drawings, an orthogonal coordinate system defined by the X, Y, and Z axes is illustrated.

[Painting System]

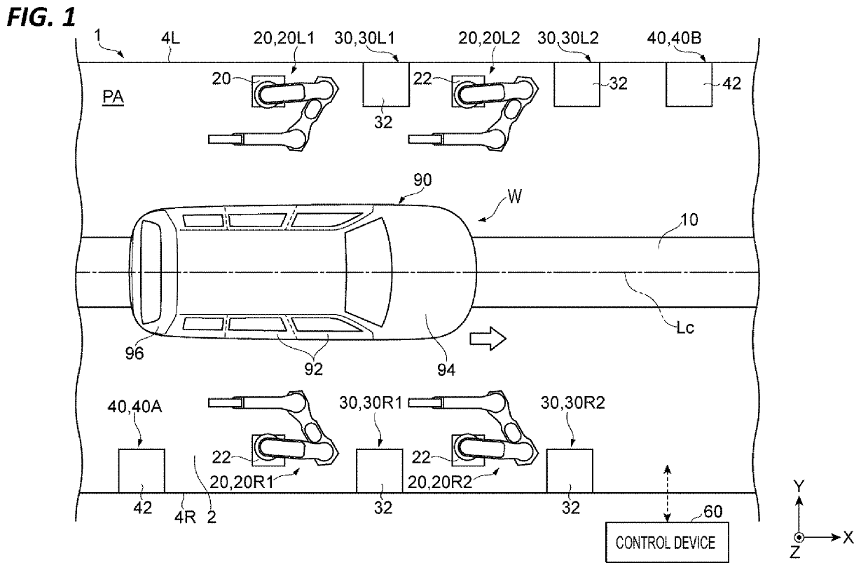

A painting system 1 illustrated in FIG. 1 performs at least part of a painting work for a painting target (hereinafter, referred to as a “workpiece W”). The workpiece W is the body of a vehicle. The workpiece W is the vehicle body in a state where the components such as interior members, an engine, and windows have not been mounted. The workpiece W includes a vehicle body 90 that makes up a passenger compartment of a vehicle (e.g., a four-wheel drive car), and opening/closing members attached to the vehicle body 90. As for the opening/closing members, the workpiece W includes, for example, doors 92 (e.g., side opening/closing members) attached to both side surfaces of the vehicle body 90, respectively, a front opening/closing member 94 attached to the front of the vehicle body 90, and a rear opening/closing member 96 attached to the rear of the vehicle body 90.

One or more doors 92 (e.g., side doors) are attached to each of the left and right side surfaces of the workpiece W. Each door 92 is provided to be freely openable and closable with respect to the vehicle body 90. The door 92 may be a hinge door that pivots around a vertical axis, or may be a slide door as well. The front opening/closing member 94 (an opening/closing member) is provided at the front of the vehicle body 90 to be opened and closed by pivoting around a horizontal axis extending in the width direction of the vehicle body. The front opening/closing member 94 is, for example, a bonnet or a hood. The rear opening/closing member 96 (e.g., an opening/closing member) is provided at the rear of the vehicle body 90 to be opened and closed by pivoting around a horizontal axis extending in the width direction of the vehicle body. The rear opening/closing member 96 is, for example, a tailgate, a back door, or a trunk.

The painting system 1 is configured to perform a so-called interior panel painting. The painting system 1 paints at least the inside of the workpiece W. The portions to be painted by the painting system 1 include portions that need to be painted in a state where the opening/closing members of the workpiece W are opened. The portions to be painted by the painting system 1 include, for example, the inner sides of the doors 92, the front opening/closing member 94, and the rear opening/closing member 96, and portions exposed in a state where an opening/closing member is opened (e.g., the center pillar).

The painting system 1 paints the inside of the workpiece W while opening and closing the opening/closing members, in a state where the workpiece W is being conveyed in a painting area PA (e.g., inside a painting booth) where the painting work is performed. The painting area PA is defined by, for example, a booth bottom wall 2, a booth side wall 4R (e.g., a first side wall), a booth side wall 4L (e.g., a second side wall), and a booth ceiling. From the viewpoint of preventing the scattering of paint mist, the painting system 1 may form a downflow flowing downward from above in the painting area PA.

The painting system 1 includes a conveying apparatus 10, one or more operation robots 20, and one or more painting robots 30. The painting system 1 may include one or more opener robots 40. The painting system 1 includes, for example, a conveying apparatus 10, four operation robots 20, four painting robots 30, two opener robots 40, and a control device 60. FIG. 1 illustrates only the bases of the painting robots 30 and the opener robots 40, omitting the specific shapes thereof.

The conveying apparatus 10 conveys the workpiece W in the painting area PA. The conveying apparatus 10 is configured to convey the workpiece W along a predetermined conveyance line IU. The conveying apparatus 10 conveys the workpiece W along the conveyance line Lc while maintaining the workpiece W at a constant vertical height position. The speed of the conveyance by the conveying apparatus 10 may be constant. The conveying apparatus 10 may convey the workpiece W with the front thereof facing forward. The conveyance line Lc is a virtual line set in the horizontal direction. As the conveying apparatus 10 conveys the workpiece W along the conveyance line Lc, the center of the workpiece W in the width direction moves on the conveyance line Lc.

In the present disclosure, the horizontal direction in which the conveyance line Lc extends will be referred to as an “X-axis direction,” and the horizontal direction orthogonal to the X-axis direction will be referred to as a “Y-axis direction.” The X-axis direction corresponds to the longitudinal direction of the painting area PA, and the Y-axis direction corresponds to the width direction of the painting area PA. In the drawings, a Z-axis direction indicates the up and down direction (e.g., a vertical direction) perpendicular to both the X-axis and Y-axis directions. The terms “upstream” and “downstream” will be used with reference to the direction of the conveyance of the workpiece W by the conveying apparatus 10. The conveying apparatus 10 conveys the workpiece W from an upstream side to a downstream side along the conveyance line Lc.

When the workpiece W is conveyed in a state where the front of the vehicle body faces forward, the rear opening/closing member 96 is positioned at an upstream side of the front opening/closing member 94 in the workpiece W that is being conveyed by the conveying apparatus 10. Based on the direction in which the workpiece W is conveyed by the conveying apparatus 10 (e.g., when viewing the upstream side from the downstream side), one side in the Y-axis direction is defined as a “right side,” and the other side is defined as a “left side.” The alphabet “R” may be added to the reference numerals of the members arranged on the right side of the conveyance line Lc, and the alphabet “L” may be added to the reference numerals of the members arranged to the left side of the conveyance line Lc.

The conveying apparatus 10 is provided on the booth bottom wall 2 in the painting area PA. The conveying apparatus 10 is, for example, a conveyor. The conveying apparatus 10 is disposed between the booth side walls 4R and 4L (e.g., a pair of side walls) in the Y-axis direction. Each of the booth side walls 4R and 4L extends along the conveyance line Lc (e.g., the X-axis direction). The conveying apparatus 10 may be disposed at the center between the booth side walls 4R and 4L in the Y-axis direction. In the Y-axis direction, the distance between the booth side wall 4L and the conveyance line Lc may be substantially equal to the distance between the booth side wall 4R and the conveyance line Lc. In the present disclosure, the distance between two members is defined as the shortest distance between the members.

Each operation robot 20 opens the door 92 of the workpiece W that is being conveyed by the conveying apparatus 10. After opening the door 92, the operation robot 20 may maintain the opened state of the door 92 while the workpiece W is being conveyed. After maintaining the opened state of the door 92, the operation robot 20 may close the door 92 in the state where the workpiece W is being conveyed. The operation robot 20 is fixed in the painting area PA. The operation robot 20 is provided on the booth bottom wall 2 or the booth side wall 4R or 4L, which is a structure that makes up the painting area PA.

In the embodiment illustrated in FIG. 1, two operation robots 20 are arranged between the conveyance line Lc and the booth side wall 4R, and two operation robots 20 are arranged between the conveyance line Lc and the booth side wall 4L. The four operation robots 20 may have the same shape. One of the two operation robots 20 arranged on the right side of the conveyance line Lc will be referred to as an “operation robot 20R1,” and the other will be referred to as an “operation robot 20R2.” One of the two operation robots 20 arranged on the left side of the conveyance line Lc will be referred to as an “operation robot 20L1,” and the other will be referred to as an “operation robot 20L2.”

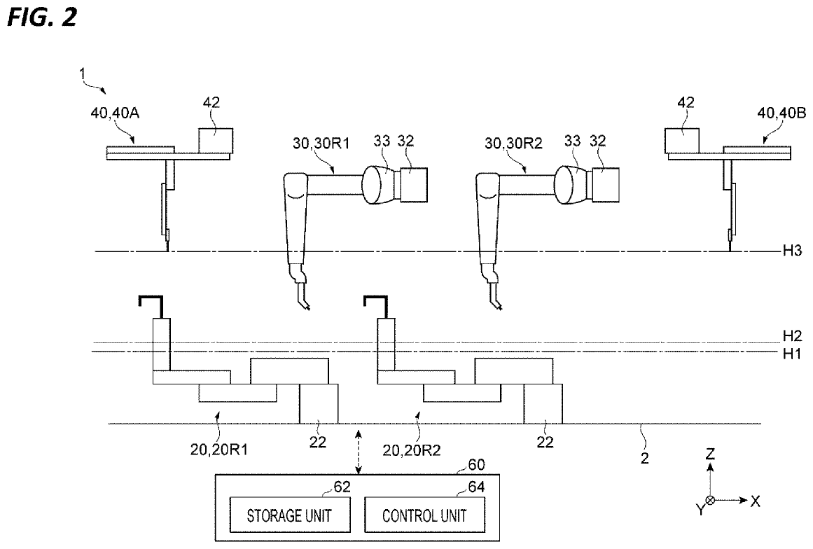

As illustrated in FIG. 1 or 2, the operation robots 20R1 and 20R2 are arranged side by side along the direction in which the workpiece W is conveyed by the conveying apparatus 10 (e.g., the X-direction). The operation robot 20R1 is disposed at an upstream side of the operation robot 20R2. In the present disclosure, the positional relationship between the robots is defined as the positional relationship between the bases of the robots. The operation robots 20L1 and 20L2 are arranged side by side along the X-axis direction. The operation robot 20L1 is disposed at the position corresponding to the operation robot 20R1 in the X-axis direction, and the operation robot 20L2 is disposed at the position corresponding to the operation robot 20R2 in the X-axis direction. FIG. 2 omits the two operation robots 20 disposed on the left side of the conveyance line Lc. Details of the operation robots 20 will be described later.

Each painting robot 30 paints the inside of the workpiece W in a state where the door 92 is opened by the operation robot 20. The painting robot 30 may be fixed in the painting area PA. The painting robot 30 may be provided on a support column or a beam included in the booth side wall 4L, or may be provided on a support column or a beam included in the booth side wall 4R. The painting robot 30 is provided to paint the painting target portion of the door 92 (e.g., the inner surface of the door 92) when the operation robot 20 opens the door 92.

In the embodiment illustrated in FIG. 1, two painting robots 30 are arranged between the conveyance line Lc and the booth side wall 4R, and two painting robots 30 are arranged between the conveyance line Lc and the booth side wall 4L. One of the two painting robots 30 arranged on the right side of the conveyance line Lc will be referred to as a “painting robot 30R1,” and the other will be referred to as a “painting robot 30R2.” One of the two painting robots 30 arranged on the left side of the conveyance line Lc will be referred to as a “painting robot 30L1,” and the other will be referred to as a “painting robot 30L2.”

The painting robots 30R1 and 30R2 are arranged side by side along the X-axis direction. The painting robot 30R1 is disposed at an upstream side of the painting robot 30R2. The painting robots 30L1 and 30L2 are arranged side by side along the X-axis direction. The painting robot 30L1 is disposed at the position corresponding to the painting robot 30R1 in the X-axis direction, and the painting robot 30L2 is disposed at the position corresponding to the painting robot 30R2 in the X-axis direction. FIG. 2 omits the two painting robots 30 disposed on the left side of the conveyance line Lc. Details of the painting robots 30 will be described later.

Each opener robot 40 opens at least one of the front opening/closing member 94 and the rear opening/closing member 96. The opener robot 40 may open either one or both of the front opening/closing member 94 and the rear opening/closing member 96. When opening the front opening/closing member 94, the opener robot 40 may move up (lift) a portion of the front opening/closing member 94, and pivot the front opening/closing member 94 around the horizontal axis. When opening the rear opening/closing member 96, the opener robot 40 may move up (lift) a portion of the rear opening/closing member 96, and pivot the rear opening/closing member 96 around the horizontal axis.

After opening the opening/closing member, the opener robot 40 may maintain the opened state of the opening/closing member while the workpiece W is being conveyed. After maintaining the opened state of the opening/closing member, the opener robot 40 may close the opening/closing member in the state where the workpiece W is being conveyed. Any one painting robot 30 may paint the painting target portion of the front opening/closing member 94 (e.g., the inner surface of the front opening/closing member 94) in a state where any one opener robot 40 opens the front opening/closing member 94. Any one painting robot 30 may paint the painting target portion of the rear opening/closing member 96 (e.g., the inner surface of the rear opening/closing member 96) in a state where any one opener robot 40 opens the rear opening/closing member 96.

The opener robot 40 may be fixed in the painting area PA. The opener robot 40 may be provided on a support column or a beam included in the booth side wall 4R, or may be provided on a support column or a beam included in the booth side wall 4L. The two opener robots 40 may be provided at different positions in the X-axis direction. One of the two opener robots 40 will be referred to as an “opener robot 40A,” and the other disposed at a downstream side of the opener robot 40A will be referred to as an “opener robot 40B.”

The opener robot 40A may be provided on the booth side wall 4R, and the opener robot 40B may be provided on the booth side wall 4L. The opener robot 40A may be provided on the booth side wall 4L, and the opener robot 40B may be provided on the booth side wall 4R. The opener robots 40A and 40B may be provided on the booth side wall 4R, or may be provided on the booth side wall 4L. The opener robot 40A may open the rear opening/closing member 96 (e.g., a first opening/closing member) without opening the front opening/closing member 94, and the opener robot 40B may open the front opening/closing member 94 (e.g., a second opening/closing member) without opening the rear opening/closing member 96. Details of the opener robots 40 will be described later. An embodiment of each robot will be described in detail herein below.

(Operation Robot)

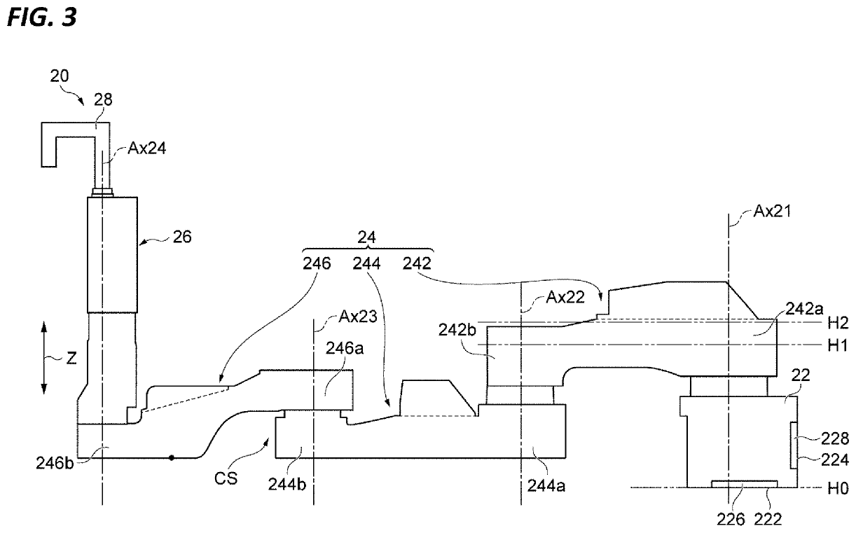

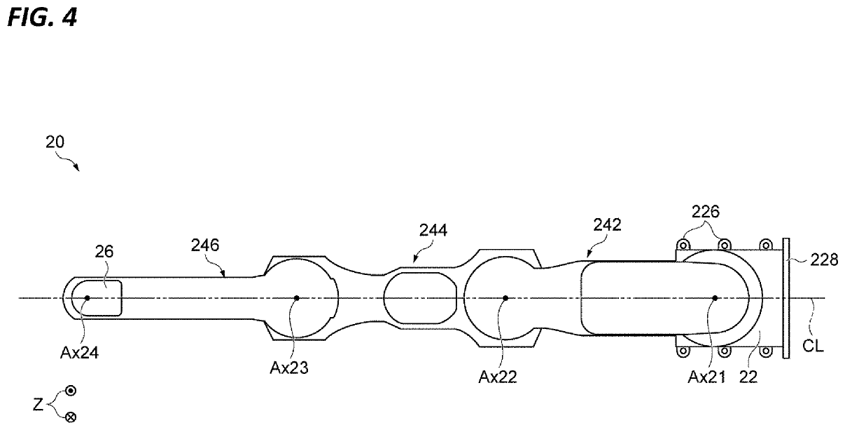

FIGS. 3 and 4 illustrate an embodiment of the operation robot 20. The operation robot 20 is a horizontal articulated robot (e.g., a so-called SCARA robot). The operation robot 20 includes, for example, a base 22, a horizontal articulated arm 24, a lifting arm 26, and a holding tool 28.

The base 22 is a portion fixed in the painting area PA. The base 22 is fixed to the structure that makes up the painting area PA, so as not to move relative to the painting area PA. The base 22 is fixed to the booth bottom wall 2 or the booth side wall 4R (e.g., the booth side wall 4L). The base 22 fixes the operation robot 20 at a predetermined position in the painting area PA, and supports a plurality of arms. The base 22 is provided at a position different from the conveyance line Lc. The base 22 is provided between the booth side wall 4R or 4L and the workpiece W that is being conveyed along the conveyance line Lc (the side surface of the vehicle body that faces the booth side wall), in the Y-axis direction.

The base 22 is provided within a range in which the workpiece W is conveyed by the conveying apparatus 10 in the X-axis direction. The workpiece W may be conveyed by the conveying apparatus 10 from a position of an upstream side of the base 22 to a position of a downstream side of the base 22 on the conveyance line IU. Since the base 22 is fixed in the painting area PA, the operation robot 20 does not move together with the workpiece W even when the workpiece W moves in the painting area PA.

The base 22 may include a rectangular parallelepiped portion. The base 22 may include a bottom surface 222 and four side surfaces. Either the bottom surface 222 or one side surface 224 of the base 222 may be attached to a predetermined position in the painting area PA. When the bottom surface 222 is attached to the painting area PA, the base 22 is fixed to the booth bottom wall 2. When the side surface 224 is attached to the painting area PA, the base 22 is fixed to the booth side wall 4R or 4L. Since any of the bottom surface 222 and the side surface 224 of the base 22 may be attached, it is possible to select between fixing the bottom surface 222 of the base 22 to the painting area PA and fixing the side surface 224 of the base 22 to the painting area PA.

The base 22 includes, for example, an attachment portion 226 provided in the bottom surface 222 and an attachment portion 228 provided in the side surface 224. In an embodiment, the attachment portion 226 is fixed to the booth bottom wall 2 by a fixing member such as a bolt, or the attachment portion 228 is fixed to the booth side wall (e.g., the booth side wall 4R or 4L) by a fixing member such as a bolt. In the embodiment illustrated in FIGS. 1 and 2, the bottom surface 222 of the base 22 of each of the operation robots 20R1 and 20R2 is attached to a portion of the booth bottom wall 2 between the workpiece W being conveyed along the conveyance line Lc and the booth side wall 4R. In the present disclosure, when the base of each robot is fixed to the structure such as the booth bottom wall or the booth side wall, the base may be directly attached to the structure, or may be attached to the structure via another member. Examples of the member provided between the base of the robot and the structure include a so-called distance piece, a grating, a spacer, and a fixing member.

The horizontal articulated arm 24 moves the holding tool 28. As the holding tool 28 moves by the horizontal articulated arm 24, the position of the holding tool 28 changes in the X-axis and Y-axis directions. The horizontal articulated arm 24 includes two or more arms. Each of the two or more arms included in the horizontal articulated arm 24 is provided to rotate around a vertical rotation axis. The horizontal articulated arm 24 includes, for example, a first arm 242, a second arm 244, and a third arm 246.

The first arm 242 is attached to the base 22 to rotate around a vertical rotation axis Ax21 (e.g., a first axis). The rotation axis Ax21 is a vertical axis that extends vertically, and the first arm 242 may rotate around the rotation axis Ax21. The first arm 242 extends away from the rotation axis Ax21. The first arm 242 extends in the direction intersecting the rotation axis Ax21 (e.g., the direction perpendicular to the rotation axis Ax21). The proximal end 242a of the first arm 242 may be attached to the base 22. The rotation axis Ax21 may pass through the proximal end 242a and the base 22. The proximal end 242a of the first arm 242 may be attached to the upper surface of the base 22.

The second arm 244 is attached to the first arm 242 to rotate around a rotation axis Ax22 (e.g., a second axis) parallel to the rotation axis Ax21. The term “parallel” includes not only being strictly parallel, but also being substantially parallel, which permits a manufacturing error or an installation error. Similarly, the terms “vertical” and “perpendicular” also include being substantially vertical and substantially perpendicular. The rotation axis Ax22 is a vertical axis that extends vertically, and the second arm 244 may rotate around the rotation axis Ax22.

The second arm 244 extends away from the rotation axis Ax22. The second arm 244 extends in the direction intersecting the rotation axis Ax22 (e.g., the direction perpendicular to the rotation axis Ax22). The proximal end 244a of the second arm 244 may be attached to the distal end 242b of the first arm 242. The rotation axis Ax22 may pass through the proximal end 244a of the second arm 244 and the distal end 242b of the first arm 242. The proximal end 242a of the second arm 244 may be attached to the lower surface of the distal end 242b of the first arm 242.

The third arm 246 is attached to the second arm 244 to rotate around a rotation axis Ax23 (e.g., a third axis) parallel to the rotation axis Ax21. The rotation axis Ax23 is a vertical axis that extends vertically, and the second arm 244 may rotatable around the rotation axis Ax23. The third arm 246 extends away from the rotation axis Ax23. The third arm 246 extends in the direction intersecting the rotation axis Ax23. The third arm 246 is formed to extend in a single horizontal direction when viewed from the vertical direction. The proximal end 246a of the third arm 246 may be attached to the distal end 244b of the second arm 244. The rotation axis Ax23 may pass through the proximal end 246a of the third arm 246 and the distal end 244b of the second arm 244. The proximal end 246a of the third arm 246 may be attached to the upper surface of the distal end 244b of the second arm 244.

In the vertical direction, at least a portion of the horizontal articulated arm 24 is disposed at a position lower than the height of the lower end of the door 92. The height of the lower end of the door 92 is maintained by the conveying apparatus 10. In FIG. 3, “H0” indicates the height position of the booth bottom wall 2, “H1” indicates the height position of the lower end of the workpiece W where the height position of the lower end of the workpiece W is maintained by the conveying apparatus 10, and “H2” indicates the height position of the lower end of the door 92 of the workpiece W. In the present disclosure, the height position indicates a position in the vertical direction, and the terms “high” and “low” indicate a positional relationship between positions (e.g., height positions) in the vertical direction.

At least a portion of the horizontal articulated arm 24 is disposed at a position lower than the height position H2. At least a portion of the horizontal articulated arm 24 may be disposed at a position lower than the height position H1. Of the two or more arms of the horizontal articulated arm 24, the arm positioned at the tip may be disposed at a position lower than the height position H2. The arm positioned at the tip indicates an arm positioned farthest from the base 22. The arm positioned at least at the tip of the horizontal articulated arm 24 may be disposed below the door 92 held by the holding tool 28.

The third arm 246 may be disposed at a position lower than the height position H2. In this case, at least a portion of the first arm 242 and at least a portion of the second arm 244 may be disposed at a position higher than the height position H2. The third arm 246 may be disposed at a position lower than the height position H1. In this case, at least a portion of the first arm 242 and at least a portion of the second arm 244 may be disposed at a position higher than the height position H1. When an arm is lower than a specific height position, this indicates that the uppermost position of the arm is located below the specific height position.

The second arm 244 may be disposed at a position lower than the height position H2. In this case, at least a portion of the first arm 242 and at least a portion of the third arm 246 may be disposed at a position higher than the height position H2. The second arm 244 may be disposed at a position lower than the height position H1. In this case, at least a portion of the first arm 242 and at least a portion of the third arm 246 may be disposed at a position higher than the height position H1.

The second arm 244 and the third arm 246 may be disposed at a position lower than the height position H2. In this case, at least a portion of the first arm 242 may be disposed at a position higher than the height position H2, or the first arm 242 may also be disposed at a position lower than the height position H2. The second arm 244 and the third arm 246 may be disposed at a position lower than the height position H1. In this case, at least a portion of the first arm 242 may be disposed at a position higher than the height position H1, or the first arm 242 may also be disposed at a position lower than the height position H1. The distal end 242b of the first arm 242 may be disposed at a position lower than the height position H2, and at least a portion of the distal end 242b may be disposed at a position higher than the height position H1. The second arm 244 and the third arm 246 may be provided to be disposed below the door 92 held by the holding tool 28.

At least a portion of the connection section that includes the distal end 244b of the second arm 244 and the proximal end 246a of the third arm 246 (hereinafter, referred to as a “connection section CS”) may be positioned at the same height as at least a portion of the base 22. For example, at least a portion of the connection section CS and the uppermost position of the base 22 are positioned at the same height. In this case, the lowermost position of the base 22 may not be at the same height as the connection section CS. The lowermost position of the connection section CS may be higher than the lowermost position of the base 22. The uppermost position of a member indicates a position of the highest portion of the member, and the lowermost position of a member indicates a position of the lowest portion of the member. At least a portion of the distal end 244b of the second arm 244 may be positioned at the same height as at least a portion of the base 22, and at least a portion of the proximal end 246a of the third arm 246 may be positioned at the same height as at least a portion of the base 22.

Unlike the embodiment illustrated in FIG. 3, at least a portion of the connection section CS and the lowermost position of the base 22 may be at the same height, and the uppermost position of the base 22 may not be at the same height as the connection section CS. The uppermost position of the base 22 may be at the same height as at least a portion of the connection section CS, and the lowermost position of the base 22 may be at the same height as at least a portion of the connection section CS. At least a portion of the distal end 244b of the second arm 244 may be positioned at the same height as at least a portion of the base 22, and the proximal end 246a of the third arm 246 may not be at the same height as the base 22. At least a portion of the proximal end 246a of the third arm 246 may be positioned at the same height as at least a portion of the base 22, and at least a portion of the distal end 244b of the second arm 244 may not be at the same height as the base 22. The connection section CS may be the highest portion of the second arm 244 and the third arm 246.

At least a portion of the distal end 246b of the third arm 246 and at least a portion of the second arm 244 may be positioned at the same height. For example, the lowermost position of the second arm 244 may be at the same height as at least a portion of the distal end 246b of the third arm 246. The lowermost position of the distal end 246b of the third arm 246 may be at the same height as at least a portion of the second arm 244. The distal end 246b of the third arm 246 may be lower than the proximal end 246a. The uppermost position of the distal end 246b may be lower than the uppermost position of the proximal end 246a. At least a portion of the intermediate section of the third arm 246 between the proximal end 246a and the distal end 246b may extend obliquely downward from the proximal end 246a.

At least a portion of the second arm 244 and at least a portion of the base 22 may be positioned at the same height. The lowermost position of the second arm 244 and at least a portion of the base 22 may be at the same height. At least a portion of the proximal end 244a of the second arm 244 may be positioned at the same height as at least a portion of the base 22. At least a portion of the intermediate section of the second arm 244 between the proximal end 244a and the distal end 244b may be positioned at the same height as at least a portion of the base 22.

At least a portion of the third arm 246 and at least a portion of the base 22 may be positioned at the same height. The lowermost position of the third arm 246 may be at the same height as at least a portion of the base 22. At least a portion of the distal end 246b of the third arm 246 may be positioned at the same height as at least a portion of the base 22. At least a portion of the intermediate section of the third arm 246 between the proximal end 246a and the distal end 246b may be positioned at the same height as at least a portion of the base 22.

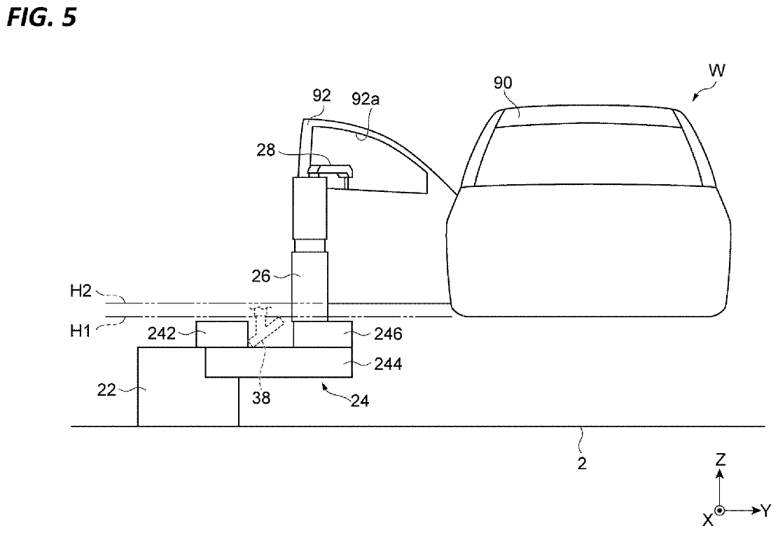

The lowermost position of the second arm 244 and the lowermost position of the third arm 246 may be higher than the booth bottom wall 2. The lowermost position of the second arm 244 is higher than the height position H0, and the lowermost position of the third arm 246 is higher than the height position H0. The second arm 244 and the third arm 246 may operate in an area defined by the portion of the booth bottom wall 2 between the workpiece W on the conveyance line Lc and the booth side wall, and a virtual horizontal plane at the height position H2 (see, e.g., FIG. 5).

The lifting arm 26 is attached to the third arm 246 to extend along the vertical direction. The lower end of the lifting arm 26 may be attached to the distal end 246b of the third arm 246. The lifting arm 26 moves the holding tool 28 along the vertical direction. The holding tool 28 is attached to the lifting arm 26. The lifting arm 26 may be attached to the distal end 246b of the third arm 246 to rotate together with the holding tool 28 around a rotation axis Ax24 (a fourth axis) parallel to the rotation axis Ax21.

FIG. 4 illustrates the operation robot 20 in a state where the rotation axes Ax21, Ax22, Ax23, and Ax24 are aligned on a linear virtual line. When viewed from the vertical direction, the virtual line passing through the rotation axes Ax21, Ax22, Ax23, and Ax24 is defined as a center line CL. The operation robot 20 (more specifically, the portions of the operation robot 20 other than the holding tool 28) may be substantially axisymmetric with respect to the center line CL.

Referring back to FIG. 3, the rotation axis Ax24 is a vertical axis that extends vertically, and the lifting arm 26 may rotate around the rotation axis Ax24. Along with the rotation of the lifting arm 26 around the rotation axis Ax24, the holding tool 28 rotates around the rotation axis Ax24. The lifting arm 26 may hold the holding tool 28 to be movable up and down such that the holding tool 28 may pass through a window frame 92a of the door 92 (e.g., the inside opening of the window frame 92a). The holding tool 28 may be movable in an up and down direction to a height position at which at least a portion of the holding tool 28 may pass through the window frame 92a.

The holding tool 28 is capable of holding the door 92. The holding tool 28 may be configured to pass through the window frame 92a of the door 92 (e.g., the inside opening of the window frame 92a), and hold the inner side of the the door 92. The holding tool 28 includes, for example, an extension part and a holding part. The extension part is attached to the lifting arm 26, and is formed such that a portion of the extension part extends in the direction intersecting the vertical direction. The holding part is connected to the distal end of the extension part, and may come into contact with the inner surface of the door 92. The holding part extends toward a downward direction from the connected portion between the extension part and the holding part.

The holding part of the holding tool 28 may hold the door 92 by magnetically adsorbing the inner surface of the door 92. The holding part of the holding tool 28 may include a permanent magnet, and may have a cylindrical shape. The holding part of the holding tool 28 may be configured to be rotatable around an axis extending along the extension direction of the holding part and passing through the center of the extension part. The holding tool 28 is not limited to the embodiments described above. The holding tool 28 may be formed to be inserted into a gap between the vehicle body 90 and the door 92 of the workpiece W. After inserting the holding tool 28 into the gap, the operation robot 20 may pull the door 92, thereby opening the door 92.

In an embodiment, the operation robot 20 operates each arm such that the holding tool 28 holds the closed door 92 and opens the door 92. During the conveyance of the workpiece W along the conveyance line Lc, the operation robot 20 operates each arm to maintain the opened state of the door 92 while maintaining the state where the holding tool 28 holds the door 92. Thereafter, the operation robot 20 operates each arm to close the door 92 in the state where the holding tool 28 holds the opened door 92. FIG. 5 schematically illustrates the state where the holding tool 28 holds and opens the door 92.

The operation robot 20 may include a plurality of actuators that moves the holding tool 28. The plurality of actuators include, for example, an actuator that rotates the first arm 242 around the rotation axis Ax21, an actuator that rotates the second arm 244 around the rotation axis Ax22, and an actuator that rotates the third arm 246 around the rotation axis Ax23. The plurality of actuators include, for example, an actuator that rotates the lifting arm 26 and the holding tool 28 around the rotation axis Ax24, and an actuator that moves the holding tool 28 along the vertical direction. Examples of the actuators of the operation robot 20 include an electric actuator provided with a power source such as an electric motor.

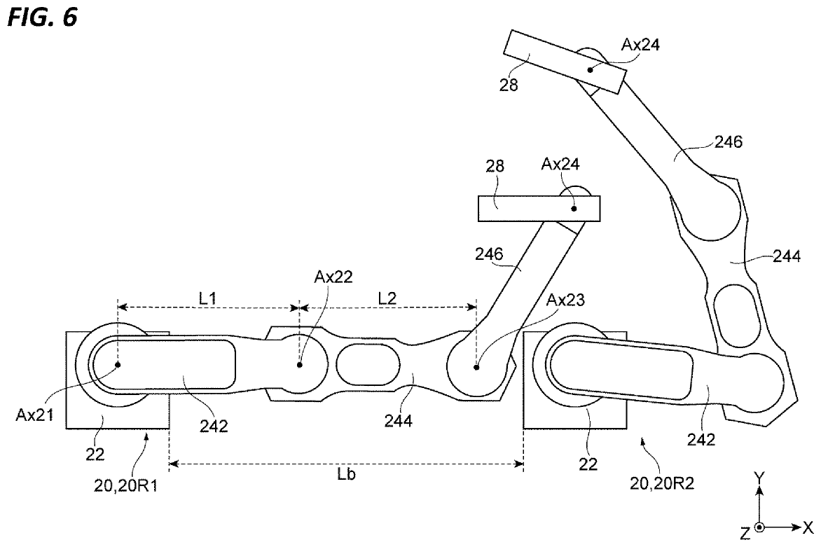

As illustrated in FIG. 6, the operation robots 20R1 and 20R2 are arranged side by side along the X-axis direction. Similarly to the operation robot 20R1, the operation robot 20R2 (e.g., a second operation robot) includes a base 22 (e.g., a second base), a horizontal articulated arm 24 (e.g., a second horizontal articulated arm), a lifting arm 26, and a holding tool 28 (e.g., a second holding tool). The horizontal articulated arm 24 of the operation robot 20R2 includes a plurality of arms that correspond to the plurality of arms included in the horizontal articulated arm 24 of the operation robot 20R1.

The base 22 of the operation robot 20R1 and the base 22 of the operation robot 20R2 may be arranged side by side in the direction in which the workpiece W is conveyed (e.g., the X-axis direction). At least a portion of the base 22 of the operation robot 20R1 and at least a portion of the base 22 of the operation robot 20R2 may be disposed at the same position in the Y-axis direction. The base 22 of the operation robot 20R1 is positioned at an upstream side of the base 22 of the operation robot 20R2 on the conveyance line Lc. In this case, the workpiece W being conveyed by the conveying apparatus 10 passes the base 22 of the operation robot 20R1 and the base 22 of the operation robot 20R2 in this order. In the present disclosure, the positional relationship between the bases in the X-axis direction is defined based on the center of each base in the X-axis direction.

A distance Lb between the base 22 of the operation robot 20R1 and the base 22 of the operation robot 20R2 is equal to or longer than the sum of an arm length L1 of the first arm 242 and an arm length L2 of the second arm 244. The arm length L1 is the distance between the rotation axes Ax21 and Ax22. The arm length L2 is the distance between the rotation axes Ax22 and Ax23. The arm lengths L1 and L2 may be substantially equal to each other. The arm lengths L1 and L2 may be different from each other.

The distance Lb corresponds to the distance in the X-axis direction between the base 22 of the operation robot 20R1 and the base 22 of the operation robot 20R2. From the viewpoint of facilitating the cooperation between the operation robots 20R1 and 20R2, the distance Lb may be equal to or shorter than a value obtained by adding the arm length L1 to the sum of the arm lengths L1 and L2.

(Painting Robot)

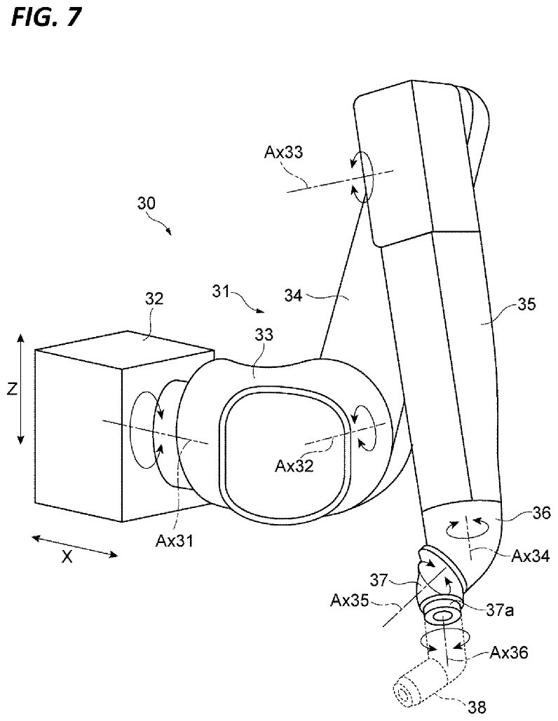

FIG. 7 is a perspective view schematically illustrating an embodiment of the painting robot 30. The painting robot 30 is capable of painting the inside of the workpiece W in cooperation with the operation robot 20. The painting robot 30 has an articulated arm that changes the position and posture of a painting tool (e.g., an ejector). The painting robot 30 illustrated in FIG. 7 is a 6-axis vertical articulated robot. The painting robot 30 includes, for example, a base 32, a vertical articulated arm 31, and an ejector 38. The vertical articulated arm 31 includes a first arm 33, a second arm 34, a third arm 35, a fourth arm 36 and a fifth arm 37.

The base 32 is a portion fixed in the painting area PA. The base 32 is fixed to the structure that makes up the painting area PA, so as not to move relative to the painting area PA. The base 32 may be fixed to the booth side wall 4R or 4L. The base 32 fixes the painting robot 30 at a predetermined position in the painting area PA, and supports a plurality of arms. The base 32 may include a rectangular parallelepiped portion, and any one of the five surfaces other than the surface with the first arm 33 provided thereon may be provided on the booth side wall.

The first arm 33 is attached to the base 32 to rotate around a rotation axis Ax31 passing through the base 32. The proximal end of the first arm 33 is attached to the base 32, and the first arm 33 may rotate around the rotation axis Ax31. The rotation axis Ax31 may extend along one horizontal direction. The proximal end of the first arm 33 may be provided on the side surface of the base 32 such that the base 32 and the first arm 33 (e.g., the proximal end of the first arm 33) are aligned in the X-axis direction, and the rotation axis Ax31 extends along the X-axis direction.

The second arm 34 is attached to the distal end of the first arm 33 to rotate around a rotation axis Ax32 intersecting the rotation axis Ax31. In the present disclosure, the term “intersecting” includes intersections having a twisted relationship, such as so-called a grade separation. The proximal end of the second arm 34 is attached to the distal end of the first arm 33, and the second arm 34 may rotate around the rotation axis Ax32. The rotation axis Ax32 is orthogonal to, for example, the rotation axis Ax31.

The third arm 35 is attached to the distal end of the second arm 34 to rotate around a rotation axis Ax33 parallel to the rotation axis Ax31. The proximal end of the third arm 35 is attached to the distal end of the second arm 34, and the third arm 35 may rotate around the rotation axis Ax33. The fourth arm 36 is attached to the distal end of the third arm 35 to rotate around a rotation axis Ax34 intersecting the rotation axis Ax33. The rotation axis Ax34 is orthogonal to, for example, the rotation axis Ax33. The proximal end of the fourth arm 36 is attached to the distal end of the third arm 35, and the fourth arm 36 may rotate around the rotation axis Ax34.

The fifth arm 37 is attached to the distal end of the fourth arm 36 to rotate around a rotation axis Ax35 intersecting the rotation axis Ax34. The proximal end of the fifth arm 37 is attached to the distal end of the fourth arm 36, and the fifth arm 37 may rotate around the rotation axis Ax35. The rotation axis Ax35 is oblique at a predetermined angle with respect to the rotation axis Ax34. The distal end 37a is provided at the opposite end of the fifth arm 37 to the proximal end thereof. The distal end 37a is attached to the opposite end of the fifth arm 37 to rotate around a rotation axis Ax36 intersecting the rotation axis Ax35. The rotation axis Ax36 is oblique at a predetermined angle with respect to the rotation axis Ax35. The ejector 38 is attached to the distal end 37a as a painting tool.

The ejector 38 is, for example, a painting gun removably attached to the distal end 37a, and is capable of ejecting a paint. FIG. 7 represents the ejector 38 with a dashed line in order to depict the distal end 37a. When the distal end 37a rotates around the rotation axis Ax36, the ejector 38 rotates around the rotation axis Ax36.

The painting robot 30 may include a plurality of actuators that changes the position and posture of the ejector 38. The plurality of actuators include, for example, an actuator that rotates the first arm 33 around the rotation axis Ax31, an actuator that rotates the second arm 34 around the rotation axis Ax32, and an actuator that rotates the third arm 35 around the rotation axis Ax33. The plurality of actuators include, for example, an actuator that rotates the fourth arm 36 around the rotation axis Ax34, an actuator that rotates the fifth arm 37 around the rotation axis Ax35, and an actuator that rotates the distal end 37a and the ejector 38 around the rotation axis Ax36. Examples of the actuators of the painting robot 30 include an electric actuator provided with a power source such as an electric motor. The painting robot 30 illustrated in FIG. 7 is an embodiment, and may be an articulated robot with multiple axes other than six.

As illustrated in FIG. 5, the ejector 38 of the painting robot 30 may be movable to a position lower than the height of the lower end of the door 92 (e.g., the height position H2). The height of the lower end of the door 92 is maintained by the conveying apparatus 10. At least a portion of the ejector 38 may be movable to a position lower than the height position H2. The ejector 38 may be movable such that a paint ejection port positioned at the distal end of the ejector 38 operates at a position lower than the height position H2. The ejector 38 (e.g., at least a portion of the ejector 38) may be movable to a position lower than the height position H1 of the lower end of the workpiece W.

The ejector 38 of the painting robot 30 may operate at a position higher than at least a portion of the horizontal articulated arm 24 included in the operation robot 20. The ejector 38 may operate at a position higher than either one of the second arm 244 and the third arm 246 of the horizontal articulated arm 24. The ejector 38 may operate at a position higher than both the second arm 244 and the third arm 246 of the horizontal articulated arm 24. The ejector 38 may operate at a position higher than the connection section CS including the distal end 244b of the second arm 244 and the proximal end 246a of the third arm 246.

(Opener Robot)

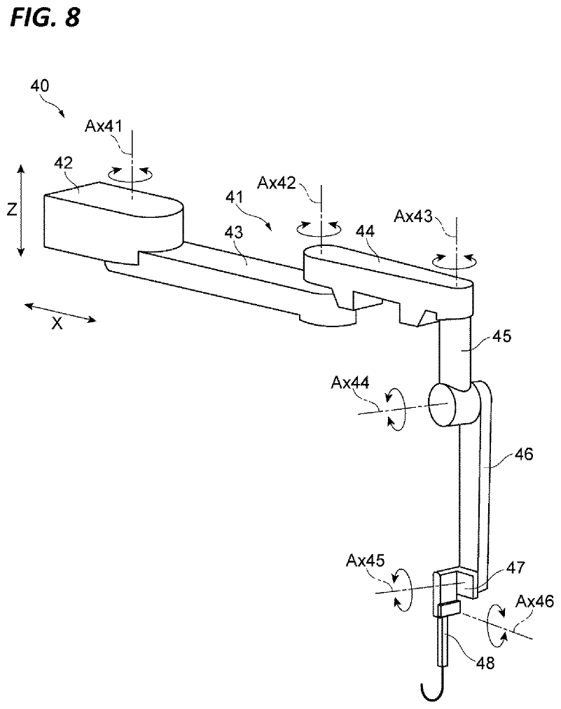

FIG. 8 is a perspective view schematically illustrating an embodiment of the opener robot 40. The opener robot 40 opens at least one of the front opening/closing member 94 and the rear opening/closing member 96, when the painting robot 30 paints the inside of the workpiece W. The opener robot 40 is an articulated robot that changes a position and posture of a work tool (e.g., a holding tool). The opener robot 40 illustrated in FIG. 8 is a 6-axis vertical articulated robot. The opener robot 40 includes, for example, a base 42, a vertical articulated arm 41, and a holding tool 48. The vertical articulated arm 41 includes a first arm 43, a second arm 44, a third arm 45, a fourth arm 46, and a fifth arm 47.

The base 42 is a portion fixed in the painting area PA. The base 42 is fixed to the structure that makes up the painting area PA, so as not to move relative to the painting area PA. The base 42 may be fixed to the booth side wall 4R or 4L. The base 42 fixes the opener robot 40 at a predetermined position in the painting area PA, and supports a plurality of arms. The base 42 may include a side surface formed along the Y-axis direction and the vertical direction. The side surface of the base 42 may be provided on the booth side wall.

The first arm 43 is attached to the base 42 to rotate around a vertical rotation axis Ax41. The proximal end of the first arm 43 is attached to the base 42, and the first arm 43 may rotate around the rotation axis Ax41. The proximal end of the first arm 43 may be attached to the lower surface of the base 42. The second arm 44 is attached to the distal end of the first arm 43 to rotate around a rotation axis Ax42 parallel to the rotation axis Ax41. The proximal end of the second arm 44 is attached to the distal end of the first arm 43, and the second arm 44 may rotate around the rotation axis Ax42. The proximal end of the second arm 44 may be attached to the upper surface of the distal end of the first arm 43.

The third arm 45 is attached to the distal end of the second arm 44 to rotate around a rotation axis Ax43 parallel to the rotation axis Ax41. The third arm 45 is formed to extend downward from the distal end of the second arm 44. The fourth arm 46 is attached to the distal end of the third arm 45 to rotate around a rotation axis Ax44 intersecting the rotation axis Ax43. The proximal end of the fourth arm 46 is attached to the distal end of the third arm 45, and the fourth arm 46 may rotate around the rotation axis Ax44. The rotation axis Ax44 may be an axis perpendicular to the rotation axis Ax43 and extending along one horizontal direction.

The fifth arm 47 is attached to the distal end of the fourth arm 46 to rotate around a rotation axis Ax45 parallel to the rotation axis Ax44. The proximal end of the fifth arm 47 is attached to the distal end of the fourth arm 46, and the fifth arm 47 may rotate around the rotation axis Ax45. The holding tool 48 is attached to the distal end of the fifth arm 47 to rotate around a rotation axis Ax46 intersecting the rotation axis Ax45. The proximal end of the holding tool 48 is attached to the distal end of the fifth arm 47, and the holding tool 48 may rotate around the rotation axis Ax46. The rotation axis Ax46 may be an axis orthogonal to the rotation axis Ax45 and extending along one horizontal direction. The holding tool 48 may be formed in a hook shape to support the front opening/closing member 94 or the rear opening/closing member 96 from below.

The opener robot 40 may include a plurality of actuators that changes the position and posture of the holding tool 48. The plurality of actuators include, for example, an actuator that rotates the first arm 43 around the rotation axis Ax41, an actuator that rotates the second arm 44 around the rotation axis Ax42, and an actuator that rotates the third arm 45 around the rotation axis Ax43. The plurality of actuators include, for example, an actuator that rotates the fourth arm 46 around the rotation axis Ax44, an actuator that rotates the fifth arm 47 around the rotation axis Ax45, and an actuator that rotates the holding tool 48 around the rotation axis Ax46. Examples of the actuators included in the opener robot 40 include an electric actuator provided with a power source such as an electric motor. The opener robot 40 illustrated in FIG. 8 is an embodiment, and may be an articulated robot with multiple axes other than six axes.

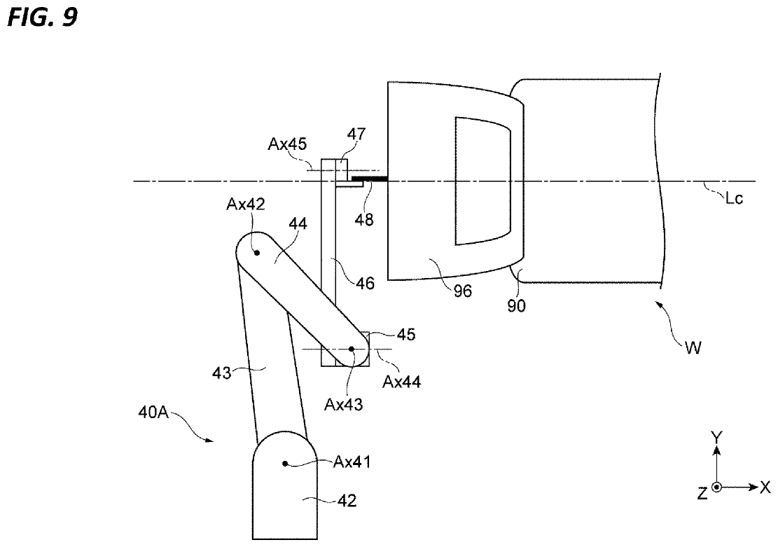

FIG. 9 schematically illustrates a view where the opener robot 40A is opening the rear opening/closing member 96 provided at the rear of the vehicle body 90. In an embodiment, the opener robot 40A rotates the first arm 43 and the second arm 44 to move the holding tool 48 close to the rear opening/closing member 96 from the area of an upstream side of the rear opening/closing member 96, and supports the distal end (e.g., a lower end) of the rear opening/closing member 96 with the holding tool 48 (e.g., hooks the holding tool 48 on the distal end of the rear opening/closing member 96). In the state of being supported by the holding tool 48, the fourth arm 46 is inclined such that the distal end of the fourth arm 46 is lower than the proximal end thereof. Then, the opener robot 40A moves up the distal end of the fourth arm 46 and raises the distal end of the rear opening/closing member 96, thereby opening the rear opening/closing member 96.

After opening the rear opening/closing member 96, the opener robot 40A may operate each arm to maintain the opened state of the rear opening/closing member 96 of the workpiece W being conveyed by the conveying apparatus 10. After maintaining the opened state of the rear opening/closing member 96, the opener robot 40A may operate each arm to close the rear opening/closing member 96.

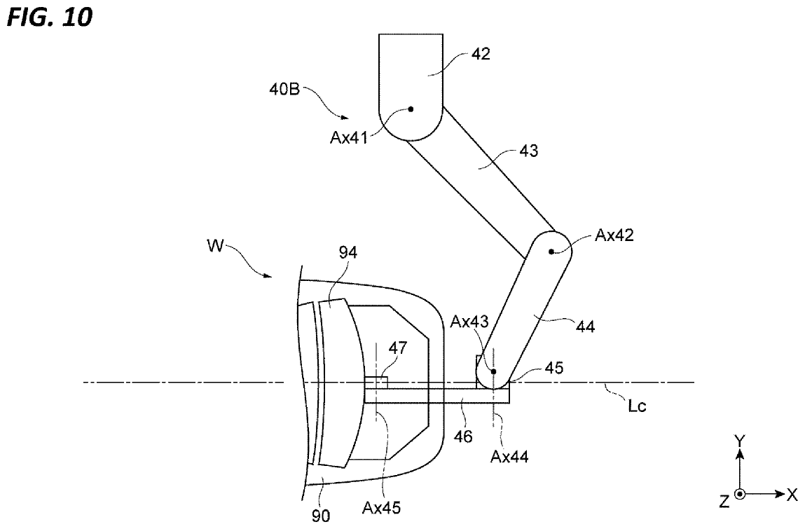

FIG. 10 schematically illustrates the opener robot 40B that is opening the front opening/closing member 94 provided at the front of the vehicle body 90. In an embodiment, the opener robot 40B rotates the first arm 43 and the second arm 44 to move the holding tool 48 close to the front opening/closing member 94 from the area of a downstream side of the front opening/closing member 94, and supports the distal end of the front opening/closing member 94 with the holding tool 48 (hooks the distal end of the front opening/closing member 94 on the holding tool 48). In the state of being supported by the holding tool 48, the fourth arm 46 is inclined such that the distal end of the fourth arm 46 is lower than the proximal end thereof. Then, the opener robot 40B moves up the distal end of the fourth arm 46 and raises the distal end of the front opening/closing member 94, thereby opening the front opening/closing member 94.

After opening the front opening/closing member 94, the opener robot 40B may operate each arm to maintain the opened state of the front opening/closing member 94 of the workpiece W being conveyed by the conveying apparatus 10. After maintaining the opened state of the front opening/closing member 94, the opener robot 40B may operate each arm to close the front opening/closing member 94.

(Positional Relationship of Robots)

Referring back to FIGS. 1 and 2, the positional relationship among the various robots will be described. The base 32 of the painting robot 30R1 may be disposed between the base 22 of the operation robot 20R1 and the base 22 of the operation robot 20R2 in the direction in which the workpiece W is conveyed by the conveying apparatus 10 (e.g., the X-axis direction). The center of the base 32 of the painting robot 30R1 in the X-axis direction may be positioned at a downstream side of the center of the base 22 of the operation robot 20R1 in the X-axis direction, and may be positioned at an upstream side of the center of the base 22 of the operation robot 20R2 in the X-axis direction. The base 32 of the painting robot 30R2 (e.g., the center of the base 32 in the X-axis direction) may be disposed near the base 22 of the operation robot 20R1, between the base 22 of the operation robot 20R1 and the base 22 of the operation 20R2.

The base 32 (e.g., the second base) of the painting robot 30R2 (e.g., the second painting robot) may not be disposed between the base 22 of the operation robot 20R1 and the base 22 of the operation robot 20R2 in the X-axis direction. The center of the base 32 of the painting robot 30R2 in the X-axis direction may be positioned at a downstream side of the center of the operation robot 20R2 in the X-axis direction. In the painting robot 30R1, the first arm 33 may be disposed at an upstream side of the base 32. In the painting robot 30R2, the first arm 33 may be disposed at an upstream side of the base 32.

The base 22 of the operation robot 20R1 and the base 22 of the operation robot 20R2 may be disposed below the base 32 of the painting robot 30R1 and the base 32 of the painting robot 30R2. The uppermost position of the base 22 of the operation robot 20R1 and the uppermost position of the base 22 of the operation robot 20R2 may be lower than the lowermost position of the base 32 of the painting robot 30R1 and the lowermost position of the base 32 of the painting robot 30R2. The lowermost position of the base 32 of the painting robot 30R1 may be higher than the height position H3 of the upper end of the workpiece W (e.g., the vehicle body 90). The height position H3 of the upper end of the workpiece W is maintained by the conveying apparatus 10. The lowermost position of the base 32 of the painting robot 30R2 may be higher than the height position H3.

The base 42 (e.g., a first base) of the opener robot 40A (e.g., a first opener robot) may be disposed at the most upstream position among the plurality of robots included in the painting system 1. The center of the base 42 of the opener robot 40A in the X-axis direction may be positioned at an upstream side of the center of the base 22 of the operation robot 20R1 in the X-axis direction. The base 42 (e.g., a second base) of the opener robot 40B (e.g., a second opener robot) may be disposed at the most downstream position among the plurality of robots included in the painting system 1. The center of the base 42 of the opener robot 40B in the X-axis direction may be positioned at a downstream side of the center of the base 32 of the painting robot 30R2 in the X-axis direction. In the X-axis direction, the base 42 of the opener robot 40A is disposed at an upstream side of the base 42 of the opener robot 40B.

The base 32 of the painting robot 30R1 and the base 32 of the painting robot 30R2 may be disposed between the base 42 of the opener robot 40A and the base 42 of the opener robot 40B in the X-axis direction. The base 32 of the painting robot 30R2 may be disposed at a position different from the base 32 of the painting robot 30R1 in the X-axis direction. At least a portion of the base 32 of the painting robot 30R2 and at least a portion of the base 32 of the painting robot 30R1 may be disposed at the same height.

As described above, the base 32 of the painting robot 30R1 may be disposed at a position different from the base 42 of the opener robot 40A in the X-axis direction. A predetermined gap may be provided between the upstream end of the base 32 of the painting robot 30R1 and the downstream end of the base 42 of the opener robot 40A in the X-axis direction. The base 32 of the painting robot 30R2 may be disposed at a position different from the base 42 of the opener robot 40B in the X-axis direction. A predetermined gap may be provided between the downstream end of the base 32 of the painting robot 30R2 and the upstream end of the base 42 of the opener robot 40B in the X-axis direction.

The base 22 of the operation robot 20R1 and the base 22 of the operation robot 20R2 may be disposed below the base 42 of the opener robot 40A and the base 42 of the opener robot 40B. The uppermost position of the base 22 of the operation robot 20R1 and the uppermost position of the base 22 of the operation robot 20R2 may be lower than the lowermost position of the base 42 of the opener robot 40A and the lowermost position of the base 42 of the opener robot 40B.

The lowermost position of the base 42 of the opener robot 40A may be higher than the height position H3 of the upper end of the workpiece W. The lowermost position of the base 42 of the opener robot 40A may be higher than the uppermost position of the base 32 of the painting robot 30R1. The lowermost position of the base 42 of the opener robot 40B may be higher than the height position H3. The lowermost position of the base 42 of the opener robot 40B may be higher than the uppermost position of the base 32 of the painting robot 30R2. At least a portion of the base 42 of the opener robot 40A and at least a portion of the base 42 of the opener robot 40B may be disposed at the same height.

(Control Device)

The control device 60 is configured with one or more computers, and controls the various robots included in the painting system 1. The control device 60 may include a plurality of computers (e.g., controllers) that individually control the plurality of robots of the painting system 1, and these computers may be connected to each other for a communication.

The control device 60 controls the conveying apparatus 10 to convey the workpiece W at least in the painting area PA, and controls the operation robot 20 to open the door 92 of the workpiece W being conveyed by the conveying apparatus 10. The control device 60 also controls the painting robot 30 to paint the inside of the workpiece W in a state where the door 92 is opened by the operation robot 20. When the operation robot 20 opens the door 92, at least a portion of the horizontal articulated arm 24 of the operation robot 20 operates at a position lower than the height position H2 of the lower end of the door 92. The height position H2 of the lower end of the door 92 is maintained by the conveying apparatus 10.

As illustrated in FIG. 2, the control device 60 includes, for example, a storage unit 62 and a control unit 64 as functional components (hereinafter, referred to as “functional modules”). The processes executed by the functional modules correspond to the processes performed by the control device 60. The storage unit 62 stores teaching information. An operator such as a worker generates the teaching information during a teaching step for teaching the operation of each of the plurality of robots included in the painting system 1. The teaching information includes a program that defines an operation path of each arm of a robot. The control unit 64 individually controls the plurality of robots included in the painting system 1 according to the teaching information.

The control device 60 includes, for example, circuitry. The circuitry of the control device 60 includes at least one processor, memory, storage, input/output port, and driver. The storage is a computer-readable non-volatile storage medium (e.g., a flash memory). The storage stores programs and data for causing the control device 60 to control the various robots included in the painting system 1. The memory temporarily stores, for example, programs loaded from the storage and results of arithmetic operations executed by the processor.

The processor implements the respective functional modules described above by executing the programs in cooperation with the memory. The driver outputs driving powers to driving sources such as the motors included in the actuators of the various robots according to commands from the processor. The input/output port inputs/outputs electric signals to/from various devices (e.g., various sensors) included in the robots according to commands from the processor. The control device 60 is not necessarily limited to implementing each function by a program. The control device 60 may implement at least part of the functions by, for example, a dedicated logic circuit or an application specific integrated circuit (ASIC) thereof.

(Control Method)

Next, a control method performed by the control device 60 will be described as an embodiment of a painting method. The control unit 64 of the control device 60 controls a corresponding robot among the plurality of operation robots 20 and the plurality of opener robots 40, to open any one of the opening/closing members among the doors 92, the front opening/closing member 94, and the rear opening/closing member 96, in a state where the workpiece W is being conveyed by the conveying apparatus 10. Hereinafter, the control of opening the opening/closing member in the state where the workpiece W is being conveyed by the conveying apparatus 10 will be referred to as an “opening control.” After performing the opening control, the control unit 64 controls the corresponding robot to maintain the opened state of the opening/closing member while following the conveyance of the workpiece W, in the state where the workpiece W is being conveyed by the conveying apparatus 10. Hereinafter, the control of maintaining the opened state of the opening/closing member in the state where the workpiece W is being conveyed by the conveying apparatus 10 will be referred to as a “following control.”

After performing the following control, the control unit 64 controls the corresponding robot to close the opening/closing member in the state where the workpiece W is being conveyed by the conveying apparatus 10. Hereinafter, the control of closing the opening/closing member in the state where the workpiece W is being conveyed by the conveying apparatus 10 will be referred to as a “closing control.” A series of controls including the opening control, the following control, and the closing control may be referred to as an “opening/closing control.”

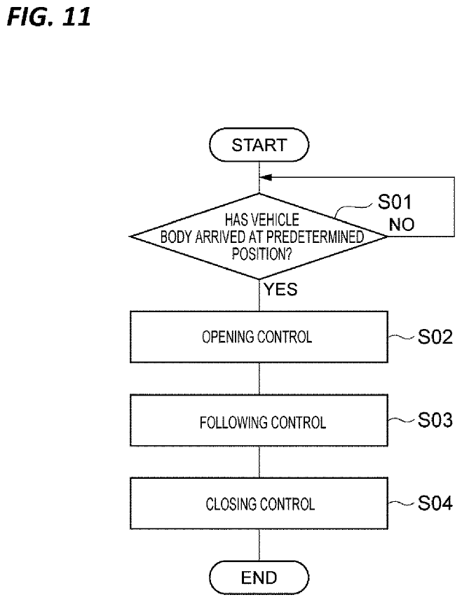

FIG. 11 is a flowchart illustrating a series of processes in the opening/closing control performed for one opening/closing member. It is determined in advance which robots perform the opening/closing control for the plurality of opening/closing members included in the workpiece W. For each of the plurality of opening/closing members, a position of the workpiece W in the X-axis direction at which the opening/closing control starts and a position of the workpiece W in the X-axis direction at which the opening/closing control ends may be determined in advance.

In the series of processes aforementioned, the control device 60 first performs step S01. In step S01, for example, the control unit 64 waits until the workpiece W arrives at a predetermined position in the X-axis direction where the operation of opening an opening/closing member to be operated (hereinafter, referred to as a “target opening/closing member”) starts. The control unit 64 may repeat step S01 by acquiring information indicating the position of the workpiece W in a predetermined period from another control device or a host controller that controls the conveying apparatus 10.

Next, the control device 60 performs step S02. In step S02, for example, the control unit 64 controls a corresponding robot to perform the opening control for the target opening/closing member. In an embodiment, when the target opening/closing member is the door 92, the control unit 64 controls the corresponding operation robot 20 to open the door 92.

Next, the control device 60 performs step S03. In step S03, for example, the control unit 64 controls the corresponding robot to perform the following control for the target opening/closing member. In an embodiment, when the target opening/closing member is the door 92, the control unit 64 controls the operation robot 20 that has opened the door 92, to maintain the opened state of the door 92. The control unit 64 controls one or more painting robots 30 to paint a portion that needs to be painted in the opened state of the target opening/closing member, during a time period overlapping with at least part of the time period when step S03 is performed.

Next, the control device 60 performs step S04. In step S04, for example, the control unit 64 controls the corresponding robot to perform the closing control for the target opening/closing member. In an embodiment, when the target opening/closing member is the door 92, the control unit 64 controls the corresponding operation robot 20 to close the door 92. Then, the control unit 64 ends the opening/closing control for one opening/closing member.

Next, descriptions will be made on a series of processes performed by the control device 60 when the workpiece W has two doors 92 on each of the left and right sides of the vehicle body 90. Of the two doors 92, the door 92 positioned at a front side of the vehicle body 90 will be referred to as a “front door 92f,” and the door 92 positioned at a rear side of the vehicle body 90 will be referred to as a “rear door 92r.” In an embodiment, the control device 60 controls the opener robot 40A to perform the opening/closing control for the rear opening/closing member 96, and controls the operation robots 20R1 and 20L1 to perform the opening/closing control for the pair of rear doors 92r, respectively. The control device 60 controls the opener robot 40B to perform the opening/closing control for the front opening/closing member 94, and controls the operation robots 20R2 and 20L2 to perform the opening/closing control for the pair of front doors 92f, respectively.

The control device 60 may first control the operation robots 20R1 and 20L1 to start the opening/closing control for the pair of left and right rear doors 92r of the vehicle body 90, respectively. After the start of the opening/closing control for the rear doors 92r, the control device 60 may control the opener robot 40A to start the opening/closing control for the rear opening/closing member 96. The control device 60 may perform the opening/closing control for the rear opening/closing member 96 during a time period overlapping with at least part of the time period when the opening/closing control for the rear doors 92r is performed.

The control device 60 may control the opener robot 40B to start the opening/closing control for the front opening/closing member 94, after the start and before the end of the opening/closing control for the rear opening/closing member 96. The control device 60 may control the operation robots 20R2 and 20L2 to start the opening/closing control for the pair of left and right front doors 92f of the vehicle body 90, respectively, after the start and before the end of the opening/closing control for the rear doors 92r. The control device 60 may perform the opening/closing control for the front opening/closing member 94 during a time period overlapping with at least part of the time period when the opening/closing control for the front doors 92f is performed.

The opening/closing controls for the rear opening/closing member 96, the rear doors 92r, the front doors 92f, and the front opening/closing member 94 may be performed such that the time periods for performing the opening/closing controls at least partially overlap with each other. The control device 60 may control the painting robots 30R1 and 30L1 to paint the painting target portions of the rear opening/closing member 96 and the rear doors 92r during at least part of the time period when the opening/closing controls for the rear opening/closing member 96 and the rear doors 92r are performed. The control device 60 may control the painting robots 30R2 and 30L2 to paint the painting target portions of the front doors 92f and the front opening/closing member 96 during at least part of the time period when the opening/closing controls for the front doors 92f and the front opening/closing member 96 are performed.

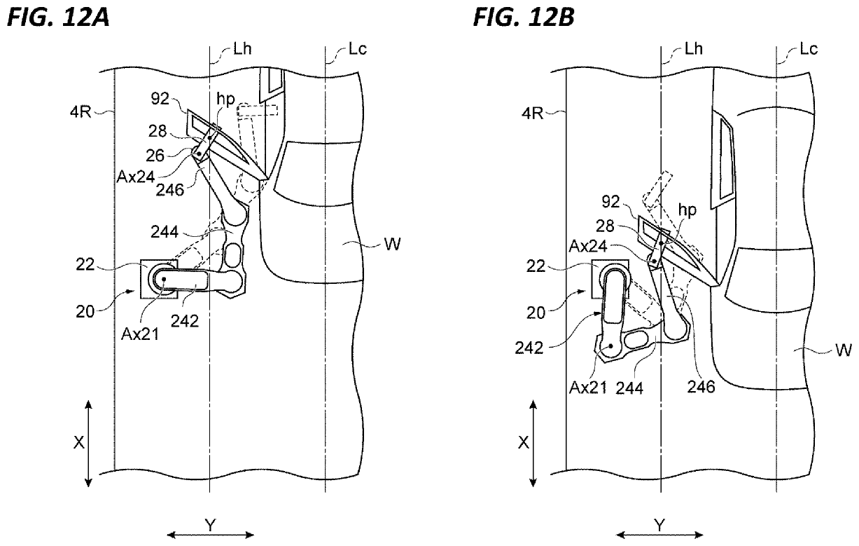

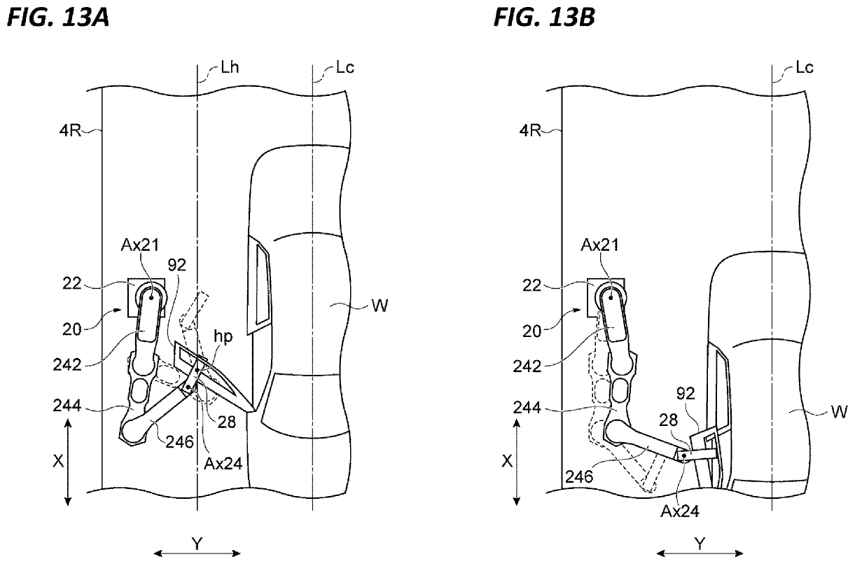

Next, an embodiment of the opening/closing control for one door 92 will be described in detail with reference to FIGS. 12A, 12B, 13A, and 13B. FIG. 12A illustrates the opening control performed in step S02. The control unit 64 of the control device 60 may control the operation robot 20 such that the holding tool 28 holds the closed door 92 and opens the door 92 in the area of an upstream side of the rotation axis Ax21 on the conveyance line Lc (e.g., in a direction of the conveyance line Lc). The control unit 64 may control the operation robot 20 to maintain the state where the holding tool 28 is positioned at an upstream side of the rotation axis Ax21 during the time period when step S02 is performed. The control unit 64 may perform the opening control of step S02 before at least a portion of the door 92 to be opened reaches the base 22 in the X-axis direction (e.g., when the door 92 is positioned at an upstream side of the base 22).

FIGS. 12B and 13A illustrate the following control performed in step S03. After performing the opening control, the control unit 64 controls the operation robot 20 to follow the movement of the workpiece W and move the position of the holding tool 28 in the X-axis direction toward the downstream side, while maintaining the opened state of the door 92. In the following control, the control unit 64 may control the operation robot 20 to move the portion of the holding tool 28 that holds the door 92 on a virtual line Lh parallel to the conveyance line IU. The portion of the holding tool 28 that holds the door 92 is, for example, the portion of the holding tool 28 which is in contact with the inside surface of the door 92, when viewed from the vertical direction.

In the following control, the control unit 64 may control the operation robot 20 to move the portion of the holding tool 28 that holds the door 92 on the line Lh, while maintaining the relative position and posture of the holding tool 28 with respect to the opened door 92. In the following control, the control unit 64 may control the door 92 such that a virtual line connecting the portion of the holding tool 28 in contact with the door 92 and the rotation axis Ax24 has a predetermined angle with respect to the door 92 when viewed from the vertical direction.

FIG. 13B illustrates the closing control performed in step S04. The control unit 64 may control the operation robot 20 such that the holding tool 28 holds the opened door 92 and closes the door 92 in the area of a downstream side of the rotation axis Ax21 on the conveyance line Lc. The control unit 64 may control the operation robot 20 to maintain the state where the holding tool 28 is positioned at a downstream side of the rotation axis Ax21 during the time period when step S04 is performed. The control unit 64 may perform the closing control of step S04 after the door 92 that has been held in step S03 passes the base 22 (e.g., when the door 92 is positioned at a downstream side of the base 22).

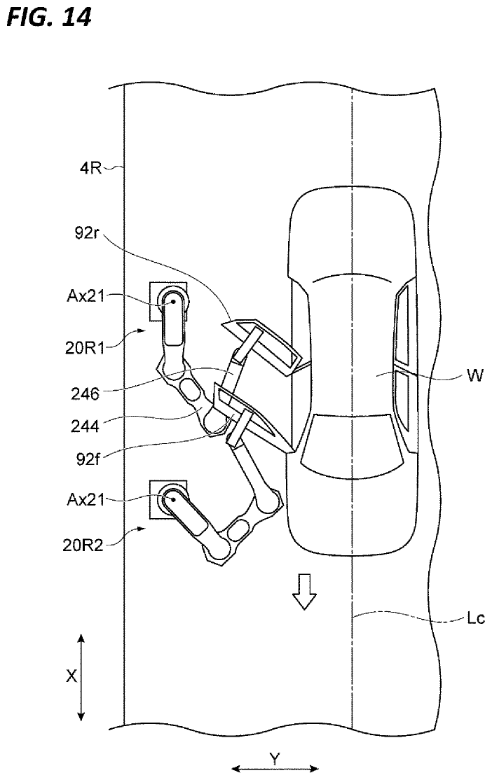

FIG. 14 illustrates a state where the operation robot 20R1 is performing the opening/closing control for the rear door 92r, and the operation robot 20R2 is performing the opening/closing control for the front door 92f. During at least a part of the time period when both the opening/closing control for the rear door 92r and the opening/closing control for the front door 92f are performed, the second arm 244 and the third arm 246 of the operation robot 20R1 may operate vertically below the front door 92f opened by the operation robot 20R2. During at least a part of the time period when both the opening/closing control for the rear door 92r and the opening/closing control for the front door 92f are performed, at least a portion of the front door 92f may overlap with at least a portion of the second arm 244 of the operation robot 20R1 and at least a portion of the third arm 246 thereof, when viewed from the vertical direction.

(Modifications)

The series of processes performed by the control device 60 are an embodiment, and may be appropriately modified. In the embodiments described above, the control device 60 controls the operation robot 20R1 to perform the opening/closing control for the rear door 92r, and the operation robot 20R1 does not perform the opening/closing control for the front door 92f. The control device 60 controls the operation robot 20R2 to perform the opening/closing control for the front door 92f, and the operation robot 20R2 does not perform the opening/closing control for the rear door 92r. Instead of this control method, the control device 60 may control the operation robot 20R1 to perform the opening/closing control for the front door 92f, and may control the operation robot 20R2 to perform the opening/closing control for the front door 92f. The control device 60 may control the operation robot 20R1 to perform the opening/closing control for the rear door 92r, and may control the operation robot 20R2 to perform the opening/closing control for the rear door 92r. The control device 60 may control the operation robot 20R1 to perform the opening/closing control for the rear door 92r after performing the opening/closing control for the front door 92f. The control device 60 may control the operation robot 20R2 to perform the opening/closing control for the rear door 92r after performing the opening/closing control for the front door 92f.

In the embodiments described above, the opening control is performed in the manner that the holding tool 28 of the operation robot 20 opens the door 92 in the area of an upstream side of the rotation axis Ax21. Instead, the opening control may be performed in the manner that the holding tool 28 opens the door 92 at a position overlapping with the rotation axis Ax21 in the X-axis direction or in an area including the area of a downstream side of the rotation axis Ax21. In the embodiment described above, the closing control is performed in the manner that the holding tool 28 of the operation robot 20 closes the door 92 in the area of a downstream side of the rotation axis Ax21. Instead, the closing control may be performed in the manner that the holding tool 28 closes the door 92 at a position overlapping with the rotation axis Ax21 in the X-axis direction or in an area including the area of an upstream side of the rotation axis Ax21.

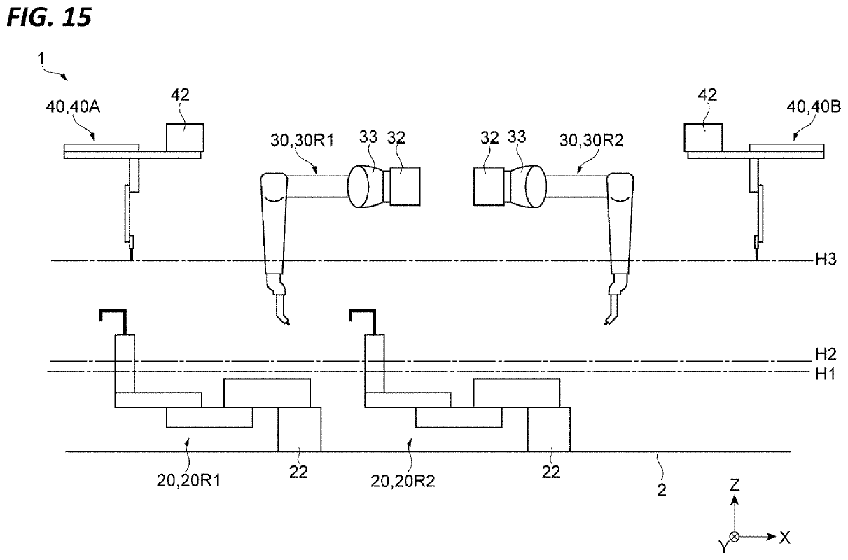

In the painting system 1, the positional relationship among the various robots is not limited to the embodiments described above. The painting system 1 illustrated 40&63 in FIG. 15 is different from the painting system 1 illustrated in FIGS. 1 and 2, in that both the bases 32 of the two painting robots 30 are disposed between the base 22 of the operation robot 20R1 and the base 22 of the operation robot 20R2 in the X-axis direction. The base 32 of the painting robot 30R2 may be disposed between the base 32 of the painting robot 30R1 and the base 22 of the operation robot 20R2 in the X-axis direction. The center of the base 32 of the painting robot 30R2 in the X-axis direction may be positioned at a downstream side of the center of the base 32 of the painting robot 30R1 in the X-axis direction, and may be positioned at an upstream side of the center of the base 22 of the operation robot 20R2 in the X-axis direction. In the painting robot 30R2, the first arm 33 may be disposed at a downstream side of the base 32.

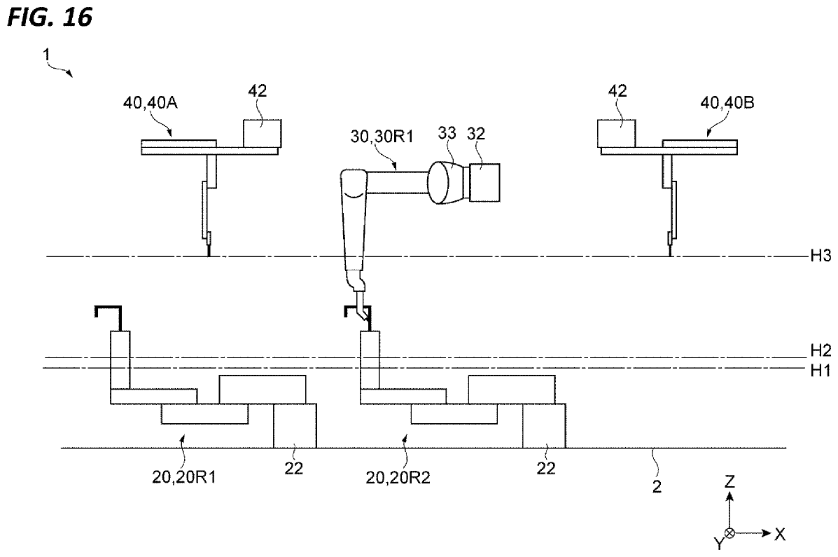

The number of various robots is not limited to the embodiments described above. Two painting robots 30 may be disposed between the opener robots 40A and 40B with no other painting robots being disposed. In the area on the left side of the conveyance line Lc, one painting robot 30 (e.g., the painting robot 30L1) may be disposed with no other painting robots being disposed. In the area on the right side of the conveyance line Lc, one painting robot 30 (e.g., the painting robot 30R1) may be disposed with no other painting robots being disposed. As illustrated in FIG. 16, the base 32 of the painting robot 30R1 is disposed between the base 42 of the opener robot 40A and the base 42 of the opener robot 40B in the X-axis direction.

The base 32 of the painting robot 30R1 may be disposed between the base 32 of the operation robot 20R1 and the base 22 of the operation robot 20R2 in the X-axis direction. The first arm 33 may be disposed at an upstream side of the base 32, and the base 32 may be disposed near the base 22 of the operation robot 20R2 between the base 22 of the operation robot 20R1 and the base 22 of the operation robot 20R2. In the painting system 1 illustrated in FIG. 16, the first arm 33 may be disposed at a downstream side of the base 32, and the base 32 may be disposed near the base 22 of the operation robot 20R1 between the base 22 of the operation robot 20R1 and the base 22 of the operation robot 20R2.

In the painting system 1 illustrated in FIG. 16, one opener robot 40 may be provided, instead of the two opener robots 40. The painting system 1 may include one opener robot 40, and may not include any other opener robots. A single opener robot 40 may be disposed at an upstream side of the center of the base 22 of the operation robot 20R1 in the X-axis direction. A single opener robot 40 may be disposed between the center of the base 22 of the operation robot 20R1 in the X-axis direction and the base 22 of the operation robot 20R2. A single opener robot 40 may be disposed at a downstream side of the center of the base 22 of the operation robot 20R2 in the X-axis direction. The control device 60 may control the single opener robot 40 to perform the opening/closing control for the front opening/closing member 94, and then, may control the same opener robot 40 to perform the opening/closing control for the rear opening/closing member 96.

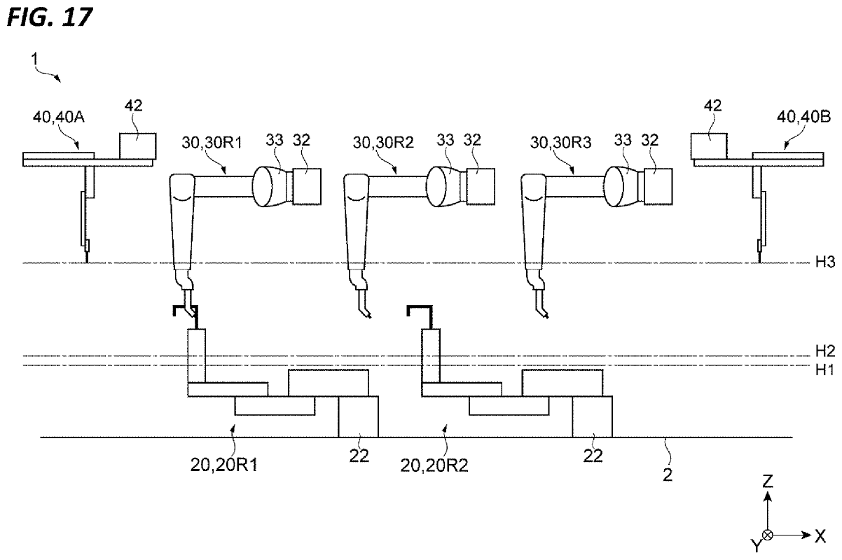

A group of six painting robots 30 may be disposed between the opener robots 40A and 40B with no other painting robot being disposed. A group of three painting robots 30 may be disposed in the area on the left side of the conveyance line Lc with no other painting robots being disposed. A group of three painting robots 30 (e.g., painting robots 30R1, 30R2, and 30R3) may be disposed in the area on the right side of the conveyance line Lc with no other painting robots being disposed. As illustrated in FIG. 17, the bases 32 of the respective painting robots 30R1, 30R2, and 30R3 may be disposed between the base 42 of the opener robot 40A and the base 42 of the opener robot 40B in the X-axis direction.

The base 32 of the painting robot 30R1 is disposed between the base 42 of the opener robot 40A and the base 22 of the operation robot 20R1 in the X-axis direction. The base 32 of the painting robot 30R2 is disposed between the base 22 of the operation robot 20R1 and the base 22 of the operation robot 20R2 in the X-axis direction. The base 32 of the painting robot 30R3 is disposed between the base 22 of the operation robot 20R2 and the base 22 of the opener robot 40B in the X-axis direction.

In each of the painting robots 30R1, 30R2, and 30R3, the first arm 33 may be disposed at an upstream side of the base 32. Unlike the embodiment illustrated in FIG. 17, the first arm 33 may be disposed at a downstream side of the base 32 in at least a portion of the painting robots 30R1, 30R2, and 30R3.

A group of four or more painting robots 30 may be provided in each of the areas on the left and right sides of the conveyance line Lc. In each of the areas on the left and right sides of the conveyance line Lc, a single operation robot 20 may be provided with no other operation robots being provided. In each of the areas on the left and right sides of the conveyance line Lc, three or more operation robots 20 may be provided. The number of operation robots 20 may differ from each other and the number of painting robots 30 may differ from each other, between the areas on the left and right sides of the conveyance line Lc.

The horizontal articulated arm 24 of the operation robot 20 may include the first arm 242 and the second arm 244 without the third arm 246. In this case, the second arm 244 positioned at the tip of the horizontal articulated arm 24 may be disposed at a position lower than the height position H2 of the lower end of the door 92 of the workpiece W. The lifting arm 26 may be attached to the distal end 244b of the second arm 244. The horizontal articulated arm 24 may include four or more arms rotatable around a vertical axis.

The second arm 244 may be attached to the lower surface of the distal end 242b of the first arm 242, and the third arm 246 may be attached to the lower surface of the distal end 244b of the second arm 244. In this case, the distal end 244b of the second arm 244 may be higher than the proximal end 244a. The distal end 242b of the first arm 242 may be lower than the proximal end 242a. In this case, the second arm 244 may be attached to the upper surface of the distal end 242b of the first arm 242, and the third arm 246 may be attached to the lower surface of the distal end 244b of the second arm 244.

When the base 22 is provided on the booth side wall, the first arm 242 may be attached to the lower surface of the base 22. When the base 22 has an extension that extends horizontally from its body, the first arm 242 may be provided under the extension of the base 22.

### Effects of Embodiments

An embodiment of the painting system 1 described above includes: a conveying apparatus 10 that conveys a workpiece W (e.g., a vehicle body) having a door 92 in a painting area PA; an operation robot 20 that includes a base 22 fixed in the painting area PA, a holding tool 28 capable of holding the door 92 and a horizontal articulated arm 24 for moving the holding tool 28, and opens the door 92 of the workpiece W that is being conveyed by the conveying apparatus 10; and a painting robot 30 that paints the inside of the workpiece W in a state where the door 92 is opened by the operation robot 20. In the vertical direction, at least a portion of the horizontal articulated arm 24 is disposed at a position lower than the height of the lower end of the door 92 (e.g., the height position H2). The height of the lower end of the door 92 is maintained by the conveying apparatus 10.

In the painting system 1, the operation robot 20 is fixed to the painting area PA via the base 22, and when the inside of the workpiece W is painted, the fixed operation robot 20 opens the door 92 of the workpiece W that is being conveyed. In order to paint the inside of the workpiece W in the state where the door 92 is opened by the operation robot 20, it is necessary to maintain the opened state of the door 92 while following the conveyance of the workpiece W. Since the painting system 1 does not require an apparatus that conveys the operation robot 20 itself in order to follow the conveyance of the workpiece W, the vertical and horizontal areas of the painting area PA may be reduced. Further, at least a portion of the horizontal articulated arm 24 of the operation robot 20 is disposed at a position lower than the lower end of the door 92, so that the operation robot 20 and other members such as the workpiece W hardly interfere with each other even when the operation robot 20 is close to the area where the workpiece W is conveyed. Since the operation robot 20 may be disposed close to the area where the workpiece W is conveyed, the horizontal area of the painting area PA may be reduced. Therefore, the painting system 1 is useful for the space saving.

The horizontal articulated arm 24 may include a first arm 242 attached to the base 22 of the operation robot 20 to rotate around a vertical rotation axis Ax21, and extending away from the rotation axis Ax21, and a second arm 244 attached to the first arm 242 to rotate about a rotation axis Ax22 parallel to the rotation axis Ax21, and extending away from the rotation axis Ax22. In the vertical direction, the second arm 244 may be disposed at a position lower than the height position H2 of the lower end of the door 92. The height position H2 of the lower end of the door 92 is maintained by the conveying apparatus 10. As compared with the first arm 242, the second arm 244 operates in an area close to the workpiece W. In this configuration, the second arm 244 is disposed at a position lower than the height position H2, so that the horizontal articulated arm 24 of the operation robot 20 and other members such as the workpiece W hardly interfere with each other. Thus, the operation robot 20 may be disposed closer to the area where the workpiece W is conveyed. Therefore, the painting system 1 is even more useful for the space saving.

The horizontal articulated arm 24 may include a first arm 242 attached to the base 22 of the operation robot 20 to rotate around the vertical rotation axis Ax21, and extending away from the rotation axis Ax21, a second arm 244 attached to the first arm 242 to rotate around a rotation axis Ax22 parallel to the rotation axis Ax21, and extending away from the rotation axis Ax22, and a third arm 246 attached to the second arm 244 to rotate around a rotation axis Ax23 parallel to the rotation axis Ax21, and extending away from the rotation axis Ax23. In the vertical direction, the third arm 246 may be disposed at a position lower than the height position H2 of the lower end of the door 92. The height position H2 of the lower end of the door 92 is maintained by the conveying apparatus 10. As compared with the first arm 242 and the second arm 244, the third arm 246 operates in an area close to the workpiece W. In this configuration, the third arm 246 is disposed at a position lower than the height position H2, so that the horizontal articulated arm 24 of the operation robot 20 and other members such as the workpiece W hardly interfere with each other. Thus, the operation robot 20 may be disposed closer to the area where the workpiece W is conveyed. Further, since the first arm 242, the second arm 244, and the third arm 246 are provided, the range in which the opened state of the door 92 may be maintained may be expanded even though the operation robot 20 itself is not conveyed. Thus, the painting system 1 is useful for both the saving space and the expansion of the range in which the opened state of the door 92 may be maintained.

In the vertical direction, the second arm 244 and the third arm 246 may be disposed at positions lower than the height position H2 of the lower end of the door 92. The height position H2 of the lower end of the door 92 is maintained by the conveying apparatus 10. As compared with the first arm 242, the second arm 244 and the third arm 246 operate in an area closer to the workpiece W. In this configuration, the second arm 244 and the third arm 246 are disposed at positions lower than the height position H2, so that the horizontal articulated arm 24 hardly interferes with other members such as the workpiece W even when a portion of the horizontal articulated arm 24 operates close to the workpiece W. Thus, the operation robot 20 may be disposed closer to the area where the workpiece W is conveyed. Therefore, the painting system 1 is more useful for the space saving.

The painting system 1 may further include an operation robot 20R2 (e.g., a second operation robot) including a base 22 (e.g., a second base) fixed in the painting area PA, a holding tool 28 (e.g., a second holding tool) capable of holding the door 92, and a horizontal articulated arm 24 (e.g., a second horizontal articulated arm) for moving the holding tool 28. The base 22 of the operation robot 20R1 and the base 22 of the operation robot 20R2 may be arranged side by side in the X-axis direction in which the workpiece W is conveyed by the conveying apparatus 10. In this case, in a state where one operation robot 20 opens one door 92, the other operation robot 20 may open another door 92. Further, since the two operation robots 20 may open one door 92 at different timings, the range in which the opened state of the door 92 may be maintained may be expanded. Therefore, the painting system 1 is useful for improving the painting efficiency or expanding the range in which the opened state of the door 92 may be maintained.

The distance Lb between the base 22 of the operation robot 20R1 and the base 22 of the operation robot 20R2 may be equal to or longer than the sum of the arm length L1 of the first arm 242 and the arm length L2 of the second arm 244. In this case, the horizontal articulated arm 24 may be disposed such that the first arm 242 and the second arm 244 are aligned linearly when the operation robot 20R1 maintains the opened state of the door 92. Thus, the opened state of the door 92 may be maintained to a further downstream position from the base 22 of the operation robot 20R1. Therefore, the painting system 1 is useful for expanding the range in which the opened state of the door 92 may be maintained.

The painting system 1 may further include an operation robot 20R2 (e.g., a second operation robot) including a base 22 (e.g., a second base) fixed in the painting area PA, a holding tool 28 (e.g., a second holding tool) capable of holding the door 92, and a horizontal articulated arm 24 (e.g., a second horizontal articulated arm) for moving the holding tool 28. The painting robot 30 may include a base 32 fixed in the painting area PA. The base 32 of the painting robot 30 may be disposed between the base 22 of the operation robot 20R1 and the base 22 of the operation robot 20R2 in the X-axis direction in which the workpiece W is conveyed by the conveying apparatus 10. In this case, a single painting robot 30 may readily paint the painting target portion of any one door 92 when the operation robot 20R1 opens the corresponding door 92, and the painting target portion of any one door 92 when the operation robot 20R2 opens the corresponding door 92. Therefore, the painting system 1 is useful for simplifying the system and improving the efficiency of the painting work.

The painting robot 30 may include a base 32 fixed in the painting area PA. In the vertical direction, the base 22 of the operation robot 20 may be disposed below the base 32 of the painting robot 30. In this case, it is possible to reduce the overlapping range between the operation area of the arms included in the painting robot 30 and the operation area of the arms included in the operation robot 20. Thus, since the operation robot 20 hardly interferes with the painting robot 30, the operation robot 20 and the painting robot 30 may be arranged close to each other in the horizontal direction. Therefore, the painting system 1 is useful for reducing the horizontal area of the painting area PA.

The painting robot 30 may include an ejector 38 capable of ejecting a paint, and a vertical articulated arm 31 that changes the position and the posture of the ejector 38. In the vertical direction, the ejector 38 may be movable to a position lower than the height position H2 of the lower end of the door 92. The height position H2 of the lower end of the door 92 is maintained by the conveying apparatus 10. Since at least a portion of the horizontal articulated arm 24 is lower than the height position H2, the ejector 38 hardly interferes with the operation robot 20 even when the ejector 38 operates at a position lower than the height position H2. Thus, the ejector 38 may eject a paint from a low position, without interfering with the operation robot 20 that is opening any one door 92. Therefore, the painting system 1 is useful for improving the efficiency of the painting work.

The ejector 38 may operate at a position higher than at least a portion of the horizontal articulated arm 24 in the vertical direction. In this case, the ejector 38 hardly comes into contact with the horizontal articulated arm 24 during its operation. Therefore, the painting system 1 is useful for avoiding the interference between the operation robot 20 and the painting robot 30.

The workpiece W may include an opening/closing member openable/closable by pivoting around a horizontal axis. The painting system 1 may further include an opener robot 40 that includes a base 42 fixed in the painting area PA, and opens the opening/closing member by moving up a portion of the opening/closing member in a state where the workpiece W is being conveyed by the conveying apparatus 10. In this case, it is possible to paint not only the portion that needs to be painted by opening the door 92, but also the portion that needs to be painted by opening the opening/closing member, in one painting area PA. Therefore, the painting system is useful for improving the efficiency of the painting work.

In the vertical direction, the base 22 of the operation robot 20 may be disposed below the base 42 of the opener robot 40. In this case, it is possible to reduce the overlapping range between the operation area of the arms included in the opener robot 40 and the operation area of the arms included in the operation robot 20. Thus, since the operation robot 20 hardly interferes with the opener robot 40, the operation robot 20 and the opener robot 40 may be arranged close to each other in the horizontal direction. Therefore, the painting system 1 is useful for reducing the horizontal area of the painting area PA.

The painting robot 30 may include a base 32 fixed in the painting area PA. The base 42 of the opener robot 40 and the base 32 of the painting robot 30 may be disposed at different positions in the X-axis direction in which the workpiece W is conveyed by the conveyance device 10. In this case, it is possible to reduce the overlapping range between the operation area of the arms included in the opener robot 40 and the operation area of the arms included in the painting robot 30. Thus, it is possible to reduce the restriction on the operation of the painting robot 30 due to the interference with the opener robot 40. Therefore, the painting system 1 is useful for improving the efficiency of the painting work.

The workpiece W may further include a front opening/closing member 94 (e.g., a second opening/closing member) openable/closable by pivoting around a horizontal axis. The rear opening/closing member 96 (e.g., an opening/closing member) may be disposed at an upstream side of the front opening/closing member 94, in the workpiece W that is being conveyed by the conveying apparatus 10. The painting system 1 may further include an opener robot 40B (e.g., a second opener robot) that includes a base 42 (e.g., a second base) fixed in the painting area PA, and opens the front opening/closing member 94 by moving up a portion of the front opening/closing member 94 in a state where the workpiece W is being conveyed by the conveying apparatus 10. The base 42 of the opener robot 40A may be disposed at an upstream side of the base 42 of the opener robot 40B in the X-axis direction in which the workpiece W is conveyed by the conveying apparatus 10. In this case, the painting work performed by opening the front opening/closing member 94 and the painting work performed by opening the rear opening/closing member 96 may be performed during an at least partially overlapping time period. Therefore, the painting system 1 is useful for improving the efficiency of the painting work.

The painting robot 30 may include a base 32 fixed in the painting area PA. In the direction in which the workpiece W is conveyed by the conveying apparatus 10, the base 32 of the painting robot 30 may be disposed between the base 42 of the opener robot 40A and the base 42 of the opener robot 40B. In this case, it is possible to reduce the overlapping range between the operation area of the arms included in the opener robot 40 and the operation area of the arms included in the painting robot 30. Thus, it is possible to reduce the restriction on the operation of the painting robot 30 due to the interference with the opener robot 40. Therefore, the painting robot 1 is useful for improving the efficiency of the painting work.

The painting system 1 may further include a painting robot 30R2 (e.g., a second painting robot) that includes a base 32 (e.g., a second base) fixed in the painting area PA and paints the inside of the workpiece W. In the X-axis direction in which the workpiece W is conveyed by the conveying apparatus 10, the base 32 of the painting robot 30R2 may be disposed between the base 42 of the opener robot 40A and the base 42 of the opener robot 40B, and may be disposed at a position different from the base 32 of the painting robot 30R1. In this case, it is possible to reduce the overlapping range between the operation area of the arms included in the opener robot 40 and the operation area of the arms included in the painting robot 30. Thus, it is possible to reduce the restriction on the operation of the painting robot 30 due to the interference with the opener robot 40. Further, since at least two painting robots 30 are provided, at least two portions may be painted in parallel. Therefore, the painting system 1 is more useful for improving the efficiency of the painting work.

Any of the bottom surface 222 and the side surface 224 of the base 22 of the operation robot 20 may be attachable to a predetermined position in the painting area PA. In this case, the same type of operation robot 20 may be attached to any of the booth bottom wall 2 and the booth side wall that make up the painting area PA. Therefore, the painting system 1 is useful for sharing the operation robot 20.

The painting system 1 may further include an operation robot 20R2 (e.g., a second operation robot) that includes a base 22 (e.g., a second base) fixed in the painting area PA, a holding tool 28 (e.g., a second holding tool) capable of holding the door 92, and a horizontal articulated arm 24 (e.g., a second horizontal articulated arm) for moving the holding tool 28, and a painting robot 30R2 (e.g., a second painting robot) that includes a base 32 (e.g., a second base) fixed in the painting area PA, and paints the inside of the workpiece W. The painting robot 30R1 may include a base 32 fixed in the painting area PA. The horizontal articulated arm 24 of the operation robot 20R2 may include a plurality of arms that corresponds to the first arm 242, the second arm 244, and the third arm 246 of the operation robot 20R1. The painting area PA may be defined by booth side walls 4R and 4L that sandwich the conveying apparatus 10 therebetween. The operation robots 20R1 and 20R2 may be arranged between the booth side wall 4R and the conveying apparatus 10. The base 32 of the painting robot 30R1 and the base 32 of the painting robot 30R2 may be fixed to the booth side wall 4R. In this case, in a state where one operation robot 20 opens one door 92, the other operation robot 20 may open another door 92. Further, since the two operation robots 20 may open one door 92 at different timings, the range in which the opened state of the door 92 may be maintained may be expanded. Further, since the operation robot 20 includes three or more arms, the range in which the opened state of the door 92 may be maintained may be expanded even though the operation robot 20 itself is not conveyed. Therefore, the painting system 1 is useful for improving the painting efficiency or expanding the range in which the opened state of the door 92 may be maintained.

The workpiece W may include a rear opening/closing member 96 (e.g., a first opening/closing member) openable/closable by pivoting around a horizontal axis, and a front opening/closing member 94 (e.g., a second opening/closing member) openable/closable by pivoting around a horizontal axis. The rear opening/closing member 96 may be disposed at an upstream side of the front opening/closing member 94, in the workpiece W that is being conveyed by the conveying apparatus 10. The painting system 1 may further include an opener robot 40A (e.g., a first opener robot) that includes a base 42 (e.g., a first base) fixed in the painting area PA, and opens the rear opening/closing member 96 by moving up a portion of the rear opening/closing member 96 in a state where the workpiece W is being conveyed by the conveying apparatus 10, and an opener robot 40B (e.g., a second opener robot) that includes a base 42 (e.g., a second base) fixed in the painting area PA, and opens the front opening/closing member 94 by moving up a portion of the front opening/closing member 94 in a state where the workpiece W is being conveyed by the conveying apparatus 10. The base 42 of the opener robot 40A may be fixed to the booth side wall 4R or 4L. The base 42 of the opener robot 40B may be fixed to the booth side wall 4R or 4L. In this case, the painting work performed by opening the rear opening/closing member 96 may be performed during a time period that overlaps with at least part of the time period for performing the painting work performed by opening the front opening/closing member 94. Therefore, the painting system 1 is useful for improving the efficiency of the painting work.

A painting method performed in an embodiment of the painting system 1 described above includes: conveying a workpiece W having a door 92 with a conveying apparatus 10 in a painting area PA; opening the door 92 of the workpiece W that is being conveyed by the conveying apparatus 10, with an operation robot 10 including a base 22 fixed in the painting area PA, a holding tool 28 capable of holding the door 92, and a horizontal articulated arm 24 that moves the holding tool 28; and painting the inside of the workpiece W with a painting robot 30 in a state where the door 92 is opened by the operation robot 20. During the opening of the door 92 by the operation robot 20, in a vertical direction, at least a portion of the horizontal articulated arm 24 operates at a position lower than a height position H2 of a lower end of the door 92 where the height position H2 of the lower end of the door 92 is maintained by the conveying apparatus 10. In this painting method, the painting area PA may be reduced as in the painting system 1. Therefore, the painting system 1 is useful for the space saving.

According to the present disclosure, it is possible to provide a painting system and a painting method, which are useful for a space saving.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A painting system comprising:
a conveyer configured to convey a vehicle body having a door in a painting area;
an operation robot including a base fixed in the painting area, a holding tool capable of holding the door, and a horizontal articulated arm that moves the holding tool, and configured to open the door of the vehicle body that is being conveyed by the conveyer; and
a painting robot configured to paint an inside of the vehicle body in a state where the door is opened by the operation robot,
wherein in a vertical direction, at least a portion of the horizontal articulated arm is disposed at a position lower than a height of a lower end of the door, where the height of the lower end of the door is maintained by the conveyer.

2. The painting system according to claim 1, wherein the horizontal articulated arm includes:
a first arm attached to the base of the operation robot to rotate around a first axis extending along the vertical direction, and extending away from the first axis, and
a second arm attached to the first arm to rotate around a second axis parallel to the first axis, and extending away from the second axis, and
wherein in the vertical direction, the second arm is disposed at a position lower than the height of the lower end of the door.

3. The painting system according to claim 1, wherein the horizontal articulated arm includes:
a first arm attached to the base of the operation robot to rotate around a first axis extending along the vertical direction, and extending away from the first axis,
a second arm attached to the first arm to rotate around a second axis parallel to the first axis, and extending away from the second axis, and
a third arm attached to the second arm to rotate around a third axis parallel to the first axis, and extending away from the third axis, and
wherein in the vertical direction, the third arm is disposed at a position lower than the height of the lower end of the door.

4. The painting system according to claim 3, wherein in the vertical direction, the second and third arms are arranged at positions lower than the height of the lower end of the door.

5. The painting system according to claim 2, further comprising:
a second operation robot including a second base fixed in the painting area, a second holding tool capable of holding the door, and a second horizontal articulated arm that moves the second holding tool,
wherein the base of the operation robot and the second base of the second operation robot are arranged in a direction in which the vehicle body is conveyed by the conveyer.

6. The painting system according to claim 5, wherein a distance between the base of the operation robot and the second base of the second operation robot is equal to or longer than a sum of an arm length of the first arm and an arm length of the second arm.

7. The painting system according to claim 1, further comprising:
a second operation robot including a second base fixed in the painting area, a second holding tool capable of holding the door, and a second horizontal articulated arm that moves the second holding tool,
wherein the painting robot includes a base fixed in the painting area, and
in a direction in which the vehicle body is conveyed by the conveyer, the base of the painting robot is disposed between the base of the operation robot and the second base of the second operation robot.

8. The painting system according to claim 1, wherein the painting robot includes a base fixed in the painting area, and
in the vertical direction, the base of the operation robot is disposed at a position lower than the base of the painting robot.

9. The painting system according to claim 1, wherein
the painting robot includes an ejector capable of ejecting paint, and a vertical articulated arm that changes a position and a posture of the ejector, and
in the vertical direction, the ejector is movable to a position lower than the height of the lower end of the door.

10. The painting system according to claim 9, wherein in the vertical direction, the ejector operates at a position higher than at least a portion of the horizontal articulated arm.

11. The painting system according to claim 1, wherein the vehicle body includes an opening/closing member that is opened and closed by pivoting around a horizontal axis, and
the painting system further comprises an opener robot including a base fixed in the painting area, and configured to open the opening/closing member by moving up a portion of the opening/closing member in a state where the vehicle body is being conveyed by the conveyer.

12. The painting system according to claim 11, wherein in the vertical direction, the base of the operation robot is disposed at a position lower than the base of the opener robot.

13. The painting system according to claim 11, wherein the painting robot includes a base fixed in the painting area, and
the base of the opener robot and the base of the painting robot are arranged at different positions in a direction in which the vehicle body is conveyed by the conveyer.

14. The painting system according to claim 11, wherein the vehicle body further includes a second opening/closing member that is opened and closed by pivoting around a horizontal axis,
the opening/closing member is disposed at an upstream side of the second opening/closing member in the vehicle body that is being conveyed by the conveyer,
the painting system further comprises a second opener robot including a second base fixed in the painting area, and configured to open the second opening/closing member by moving up a portion of the second opening/closing member in a state where the vehicle body is being conveyed by the conveyer, and
in a direction in which the vehicle body is conveyed by the conveyer, the base of the opener robot is disposed at an upstream side of the second base of the second opener robot.

15. The painting system according to claim 14, wherein the painting robot includes a base fixed in the painting area, and
in the direction in which the vehicle body is conveyed by the conveyer, the base of the painting robot is disposed between the base of the opener robot and the second base of the second opener robot.

16. The painting system according to claim 15, further comprising:
a second painting robot including a second base fixed in the painting area, and configured to paint an inside of the vehicle body,
wherein in the direction in which the vehicle body is conveyed by the conveyer, the second base of the second painting robot is disposed between the base of the opener robot and the second base of the second opener robot, and is disposed at a position different from a position of the base of the painting robot.

17. The painting system according to claim 1, wherein any of a bottom surface and a side surface of the base of the operation robot is attachable to a predetermined position in the painting area.

18. The painting system according to claim 3, further comprising:
a second operation robot including a second base fixed in the painting area, a second holding tool capable of holding the door, and a second horizontal articulated arm that moves the second holding tool; and
a second painting robot including a second base fixed in the painting area, and configured to paint an inside of the vehicle body,
wherein the painting robot includes a base fixed in the painting area,
the second horizontal articulated arm includes a plurality of arms that corresponds to the first arm, the second arm, and the third arm,
the painting area is defined by a pair of side walls that sandwiches the conveyer, and
the operation robot and the second operation robot are arranged between a first side wall of the pair of side walls and the conveyer, and
the base of the painting robot and the second base of the second painting robot are fixed to the first side wall.

19. The painting system according to claim 18, wherein
the vehicle body includes a first opening/closing member that is opened and closed by pivoting around a horizontal axis, and a second opening/closing member that is opened and closed by pivoting around a horizontal axis,
the first opening/closing member is disposed at an upstream side of the second opening/closing member in the vehicle body that is being conveyed by the conveyer,
the painting system further comprises:
a first opener robot including a first base fixed in the painting area, and configured to open the first opening/closing member by moving up a portion of the first opening/closing member in a state where the vehicle body is being conveyed by the conveyer; and
a second opener robot including a second base fixed in the painting area, and configured to open the second opening/closing member to move up a portion of the second opening/closing member in a state where the vehicle body is being conveyed by the conveyer,
the first base of the first opener robot is fixed to the first side wall or a second side wall of the pair of side walls, and
the second base of the second opener robot is fixed to the first side wall or the second side wall.

20. A painting method comprising:
conveying a vehicle body having a door with a conveyer in a painting area;
opening the door of the vehicle body that is being conveyed by the conveyer, with an operation robot including a base fixed in the painting area, a holding tool capable of holding the door, and a horizontal articulated arm that moves the holding tool; and
painting an inside of the vehicle body with a painting robot in a state where the door is opened by the operation robot,
wherein during the opening, in a vertical direction, at least a portion of the horizontal articulated arm operates at a position lower than a height of a lower end of the door where the height of the lower end of the door is maintained by the conveyer.
